(19) United States
(12) Patent Application Publication
(10) Pub. No.: US 2021/0326118 A1
(43) Pub. Date: Oct. 21, 2021

(54) CHIP INCLUDING MULTIPLY-ACCUMULATE MODULE, CONTROL METHOD, ELECTRONIC DEVICE, AND STORAGE MEDIUM

(71) Applicant: Tencent Technology (Shenzhen) Company Limited, Shenzhen (CN)

(72) Inventor: Jia Xin LI, Shenzhen (CN)

(73) Assignee: Tencent Technology (Shenzhen) Company Limited, Shenzhen (CN)

(21) Appl. No.: 17/362,374

(22) Filed: Jun. 29, 2021

Related U.S. Application Data
(63) Continuation of application No. PCT/CN2019/126829, filed on Dec. 20, 2019.

(30) Foreign Application Priority Data
Jan. 4, 2019 (CN) 201910008593.9

(51) Int. Cl. G06F 7/544; G06F 7/501; G06F 7/556; G06F 7/483; G06F 7/48

(52) U.S. Cl. CPC G06F 7/5443; G06F 7/501; G06F 7/4824; G06F 7/483; G06F 7/556

(57) ABSTRACT

A chip includes a multiply accumulate module with a fixed-point general-purpose unit, a floating-point special-purpose unit, and an output selection unit. The fixed-point general-purpose unit and the floating-point special-purpose unit share one group of multipliers. In the multiply accumulate module of the chip, the fixed-point operation and the floating-point operation are integrated in one circuit, so that the multiply accumulate module implements not only the fixed-point operation, but also the floating-point operation in the circuit. Sharing the multiplier by the fixed-point operation unit and the floating-point operation unit reduces a total quantity of devices used, and reduces power consumption during operation.

### RELATED APPLICATION

This application claims priority to PCT Application PCT/CN2019/126829, filed on Dec. 20, 2019, which claims priority to Chinese Patent Application No. 201910008593.9, entitled “CHIP INCLUDING MULTIPLY ACCUMULATE MODULE, TERMINAL, AND CONTROL METHOD” filed with the China National Intellectual Property Administration on Jan. 4, 2019, both of which are incorporated herein by reference in their entirety.

### FIELD OF THE TECHNOLOGY

This application relates to the field of chips, and in particular, to a chip including a multiply accumulate module, a control method, an electronic device, and a storage medium.

### BACKGROUND OF THE DISCLOSURE

A multiply accumulate module is a basic calculation module on a chip, and is widely applicable to a chip such as a central processing unit (CPU), a field programmable gate array (FPGA), an application-specific integrated circuit (ASIC), a graphics processing unit (GPU), or another artificial intelligence (AI) chip.

A chip for neural network model calculation is used as an example. Two types of multiply accumulate modules coexist on the chip: a first type of the multiply accumulate module for a fixed-point operation (also referred to as an integer operation), and a second type of the multiply accumulate module for a floating-point operation. When the fixed-point operation is required, the first type of the multiply accumulate module is invoked for operation. When the floating-point operation is required, the second type of the multiply accumulate module is invoked for operation.

Because the two types of multiply accumulate modules both need to be implemented on a chip, a chip area and power consumption of the chip are relatively large.

### SUMMARY

According to various embodiments provided in this application, a chip including a multiply accumulate module, a control method, an electronic device, and a storage medium are provided.

According to an embodiment of this application, a chip including a multiply accumulate module is provided, the chip including a multiply accumulate module, the multiply accumulate module including: a first input end and a second input end configured to input multiplication numbers, an upper-level input end configured to input an addition number, a mode selection end configured to select a fixed-point arithmetic mode or a floating-point arithmetic mode and a module output end.

The multiply accumulate module further includes: a fixed-point general-purpose unit, a floating-point special-purpose unit, and an output selection unit;

the fixed-point general-purpose unit being separately connected to the first input end, the second input end, the upper-level input end, and the mode selection end, and a fixed-point output end of the fixed-point general-purpose unit being separately connected to the output selection unit and the floating-point special-purpose unit;

the floating-point special-purpose unit being separately connected to the first input end, the second input end, the upper-level input end, the fixed-point output end, and the mode selection end, and a floating-point output end of the floating-point special-purpose unit being connected to the output selection unit; and

the output selection unit being configured to: set an arithmetic mode according to a selection signal inputted by the mode selection end, and connect the fixed-point output end to the module output end when the arithmetic mode is the fixed-point arithmetic mode; and connect the floating-point output end to the module output end when the arithmetic mode is the floating-point arithmetic mode.

According to another embodiment of this application, a control method is provided. The method is applicable to the chip according to the foregoing embodiment, and the method includes:

receiving a first control signal;

controlling, according to the first control signal, a multiply accumulate module in the chip to be in a corresponding arithmetic mode, the arithmetic mode including a fixed-point arithmetic mode and a floating-point arithmetic mode;

multiplying, when the arithmetic mode is the fixed-point arithmetic mode, a first operand A by a second operand B, and then adding a third operand C of a calculation result of an upper-level multiply accumulate module, to obtain and output a fixed-point operation result; and

performing calculation of a multiplication part in a floating-point operation on the first operand A and the second operand B when the arithmetic mode is the floating-point arithmetic mode, to obtain a first intermediate result, and outputting a floating-point operation result after operation of an addition part in the floating-point operation is performed on the first operand A, the second operand B, the third operand C, and the first intermediate result.

According to another embodiment of this application, an electronic device is provided, including the chip according to the foregoing embodiment, the chip being configured to perform the control method according to the foregoing embodiment.

According to another embodiment of this application, a non-volatile computer-readable storage medium is provided, storing computer-readable instructions, the computer-readable instructions, when executed by one or more processors, causing the one or more processors to perform the control method according to the foregoing embodiment.

Details of one or more embodiments of this application are provided in the accompanying drawings and descriptions below. Other features, objectives, and advantages of this application become apparent from the specification, the accompanying drawings, and the claims.

### BRIEF DESCRIPTION OF THE DRAWINGS

To describe the technical solutions in embodiments of this application more clearly, the following briefly describes the accompanying drawings required for describing the embodiments. Apparently, the accompanying drawings in the following descriptions show only some embodiments of this application, and a person of ordinary skill in the art may still derive other accompanying drawings from the accompanying drawings.

FIG. 1 is a diagram of comparison between calculation precisions of fixed-point integer arithmetic and floating-point arithmetic according to the related art.

FIG. 2 is a schematic structural diagram of a multiply accumulate module with an input bit width of 16 bits according to the related art.

FIG. 3 is a schematic structural diagram of a multiply accumulate module with an input bit width of 8 bits according to the related art.

FIG. 4 is a schematic structural diagram of a multiply accumulate module in a chip according to an example embodiment of this application.

FIG. 5 is a schematic structural diagram of a fixed-point general-purpose unit in a multiply accumulate module according to an example embodiment of this application.

FIG. 6 is a schematic structural diagram of a floating-point special-purpose unit in a multiply accumulate module according to an example embodiment of this application.

FIG. 7 is a schematic structural diagram of a multiply accumulate module in a chip according to another example embodiment of this application.

FIG. 8 is a schematic structural diagram of an application environment according to an example embodiment of this application.

FIG. 9 is a flowchart of a control method according to an example embodiment of this application.

FIG. 10 is a flowchart of a control method according to another example embodiment of this application.

FIG. 11 is a flowchart of a control method according to another example embodiment of this application.

FIG. 12 is a flowchart of a control method according to another example embodiment of this application.

FIG. 13 is a flowchart of a control method according to another example embodiment of this application.

FIG. 14 is a schematic structural diagram of an electronic device according to an example embodiment of this application.

FIG. 15 is a schematic structural diagram of an electronic device implemented as a server according to an example embodiment of this application.

### DESCRIPTION OF EMBODIMENTS

To make objectives, technical solutions, and advantages of this application clearer, the following further describes implementations of this application in detail with reference to the accompanying drawings.

First, several terms involved in this application are introduced.

Multiply accumulate (MAC) operation: an operation of multiplying a first operand A by a second operand B, and then adding a product and a third operand Cᵢₙ. That is, Cₒᵤₜ=A*B+Cᵢₙ.

Multiply accumulate module: a hardware circuit unit configured to implement a MAC operation in a digital signal processor or some microprocessors, and also referred to as a “multiplier accumulator”.

The term module (and other similar terms such as unit, submodule, etc.) may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module. A module is configured to perform functions and achieve goals such as those described in this disclosure, and may work together with other related modules, programs, and components to achieve those functions and goals.

Fixed-point number: a representation method, of a number used in a computer, for agreeing that decimal point positions of all data in a machine are fixed. Two simple agreements are generally used in a computer: fixing a position of a decimal point before the highest bit of data, or fixing a position of a decimal point after the lowest bit. Generally, the former is often referred to as a fixed-point decimal, and the latter is often referred to as a fixed-point integer. In this embodiment of this application, description is made by using an example in which the fixed-point number is the fixed-point integer. When the data is less than the minimum value that the fixed-point number can be represent, the computer processes the data as 0. This is referred to as underflow. When the data is greater than the maximum value that the fixed-point number can represent, the computer cannot represent the data. This is referred to as overflow. The overflow and underflow are collectively referred to as overflow.

Floating-point number: an identification method of another number used in a computer, which is similar to scientific notation. Any binary number N may always be written as:

N=2^{E}*M

In the formula, M is a decimal part (also referred to as mantissa) of the floating-point number N, and is a pure decimal. E is an exponent part (also referred to as an exponent) of the floating-point number N, and is an integer. This representation method is equivalent to that a decimal point position of a number may float freely with different scale factors within a range, and therefore, is referred to as a floating-point identification method.

Floating-point multiplication operation: For a first floating-point number N_{A}=2^{E}ₐ*Mₐ and a second floating-point number N_{B}=2^{E}_{b}*M_{b}, a product of the two floating-point numbers is as follows:

N_{A}*N_{B}=2^{(Ea+Eb)}*(Mₐ*M_{b})

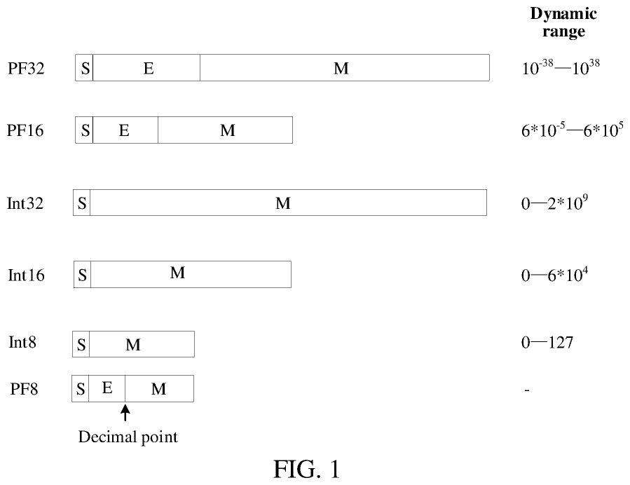

The multiply accumulate module, as a basic calculation unit, is widely applicable to CPUs, GPUs, and AI chips. The AI field is used as an example. With the development of emerging technologies such as face recognition and image classification, the calculation precision and speed requirements for the multiply accumulate module are increasingly high. It can be learned from FIG. 1 that, a dynamic range of a 32-bit floating-point FP32 is much larger than a dynamic range of a 32-bit integer Int32, and a dynamic range of a 16-bit floating-point FP16 is much larger than a dynamic range of a 16-bit integer Int16. It may be concluded that a larger dynamic range indicates a higher calculation precision. Therefore, adding a floating-point arithmetic mode to the multiply accumulate module becomes a technical solution for improving the calculation precision.

In the related art, two types of multiply accumulate modules are both configured in a chip, and are configured to support a fixed-point arithmetic mode and a floating-point arithmetic mode respectively. That is, two sets of independent hardware structures need to be designed. One set of multiply accumulate modules is configured to support the fixed-point arithmetic mode, and the other set of multiply accumulate modules is configured to support the floating-point arithmetic mode, to improve the calculation precision of the multiply accumulate modules. There is a problem that the two sets of independent hardware structures occupy a larger area on the chip and consume more energy.

If it is also needed to support both high-bit width and low-bit width fixed-point arithmetic modes, for example, for a high bit width, a set of independent hardware structures is also needed to support the low-bit width fixed-point arithmetic mode.

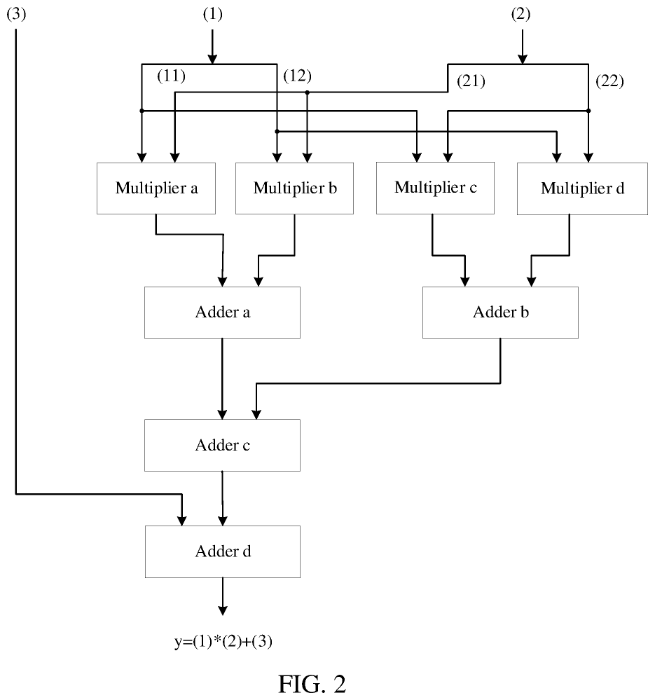

In one example, FIG. 2 shows a circuit structure of a multiply accumulate module for a fixed-point arithmetic mode in the related art. The multiply accumulate module supports a multiplication operation between two operands with a bit width of 16 bits. The circuit includes four multipliers a-d and four adders a-d, and each multiplier supports 8-bit multiplication operation. 11 in FIG. 2 is the 15^{th} bit to the 8^{th} bit of a first operand 1, and 12 is the 7^{th} bit to the 0^{th} bit of the first operand. 21 is the 15^{th} bit to the 8^{th} bit of a second operand 21, and 22 is the 7^{th} bit to the 0^{th} bit of a second operand 22.

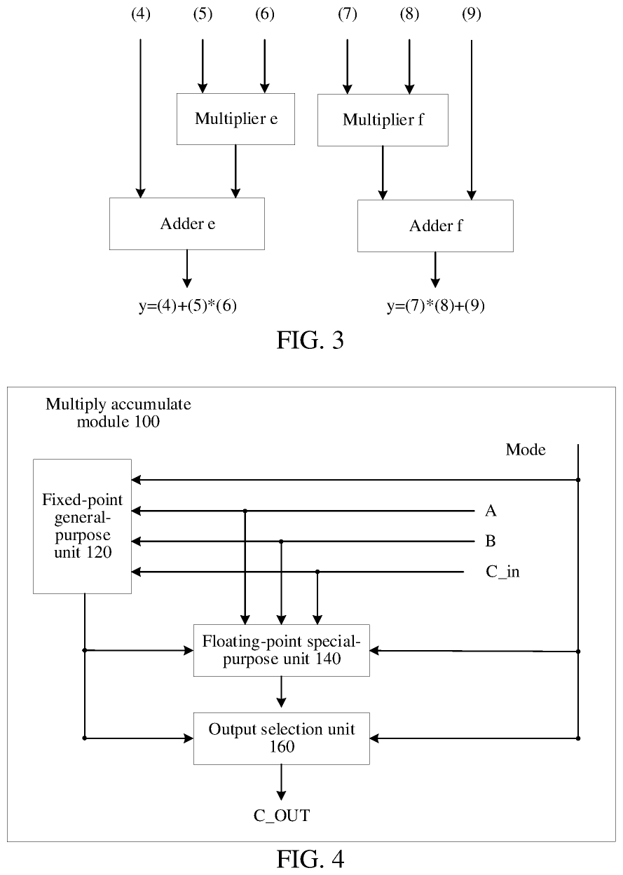

In the related art, if the multiply accumulate module needs to support a fixed-point arithmetic mode with a bit width less than 16 bits, two groups of circuit structures shown in FIG. 3 need to be added. The two groups of circuit structures both support a multiplication operation between two operands with a bit width of 8 bits, and the two groups of circuit structures include a total of two multipliers e-f and two adders e-f, while a circuit structure corresponding to the floating-point arithmetic mode includes four multipliers and six adders.

If a multiply accumulate module not only needs to support an integer multiplication operation between two operands with a bit width of 16 bits and support an integer multiplication operation between two operands with a bit width of 8 bits, but also needs to support a floating-point multiplication operation between two operands with a bit width of 16 bits, 10 multipliers and 12 adders are required. That is, hardware resource requirements in the related art are as shown in Table 1:

TABLE 1

| Multiply accumulate module configuration | Multiplier | Adder |
|---|---|---|
| 16-bit integer multiply accumulate module | 4 | 4 |
| 8-bit integer multiply accumulate module | 2 | 2 |
| 16-bit floating-point multiply accumulate module | 4 | 6 |
| 16/8-bit integer multiply accumulate module | 6 | 6 |
| 16/8-bit integer multiply accumulate module + | 10 | 12 |
| floating-point multiply accumulate module | | |

In the related art, the multiply accumulate module for fixed-point arithmetic and the multiply accumulate module for floating-point arithmetic are two independent hardware circuits, and a total quantity of required multipliers and adders is large, resulting in that a larger area needs to be occupied on the chip and power consumption is also high. An AI chip with a plurality of multiply accumulate modules is used as an example. The factors may limit manufacturability, a yield, heat dissipation, and performance of the AI chip. That is, on one hand, a larger hardware structure area results in a larger chip area, and the larger chip area results in high costs, poor manufacturability and a low yield. On the other hand, the larger hardware structure area results in high power consumption, the high power consumption results in more heat dissipation, and an excessive high temperature affects the overall performance of the chip.

To resolve the problems of the larger occupied area of the multiply accumulate modules on the chip and the higher power consumption, the embodiments of this application provide a technical solution in which the fixed-point multiply accumulate calculation and the floating-point multiply accumulate calculation are compatible in the same multiply accumulate module. Refer to the following embodiments.

FIG. 4 is a schematic structural diagram of a multiply accumulate module 100 in a chip according to an example embodiment of this application. The multiply accumulate module 100 includes: a first input end A and a second input end B configured to input multiplication numbers, an upper-level input end C_in configured to input an addition number, a mode selection end mode configured to select a fixed-point arithmetic mode or a floating-point arithmetic mode and a module output end C_OUT.

The multiply accumulate module 100 further includes: a fixed-point general-purpose unit 120, a floating-point special-purpose unit 140, and an output selection unit 160.

The fixed-point general-purpose unit 120 is separately connected to the first input end A, the second input end B, the upper-level input end C, and the mode selection end mode. A fixed-point output end of the fixed-point general-purpose unit 120 is separately connected to the output selection unit 160 and the floating-point special-purpose unit 140.

The floating-point special-purpose unit 140 is separately connected to the first input end A, the second input end B, the upper-level input end C, the fixed-point output end of the fixed-point general-purpose unit 120, and the mode selection end mode. A floating-point output end of the floating-point special-purpose unit 140 is connected to the output selection unit 160.

The output selection unit 160 is connected to the mode selection end mode. The output selection unit 160 is configured to set an arithmetic mode according to a selection signal inputted by the mode selection end.

Optionally, the arithmetic mode includes the fixed-point arithmetic mode and the floating-point arithmetic mode.

When the arithmetic mode is the fixed-point arithmetic mode, the fixed-point general-purpose unit 120 is configured to: multiply a first operand A inputted by the first input end A by a second operand B inputted by the second input end B, then add a third operand C inputted by the upper-level input end C_in, and output a fixed-point operation result from the fixed-point output end.

The output selection unit 160 connects the fixed-point output end of the fixed-point general-purpose unit 120 to the module output end C_OUT, and outputs the fixed-point operation result from the module output end C_OUT.

When the arithmetic mode is the floating-point arithmetic mode, the fixed-point general-purpose unit 120 is configured to: perform calculation of a multiplication part in a floating-point multiply accumulate operation on a first operand A inputted by the first input end and a second operand B inputted by the second input end, and output a first intermediate result from the fixed-point output end of the fixed-point general-purpose unit 120. The first intermediate result is inputted to the floating-point special-purpose unit 140. The floating-point special-purpose unit 140 is configured to: perform operation of an addition part in the floating-point multiply accumulate operation on the first operand A inputted by the first input end, the operand B inputted by the second input end, the third operand C inputted by the upper-level input end, and the first intermediate result inputted by the fixed-point output end of the fixed-point general-purpose unit 120, and then output a floating-point operation result from the floating-point output end.

The output selection unit 160 connects the floating-point output end of the floating-point special-purpose unit 140 to the module output end C_OUT, and outputs the floating-point operation result from the module output end C_OUT.

In summary, in the chip provided in this embodiment, by configuring the fixed-point general-purpose unit and the floating-point special-purpose unit in the multiply accumulate module, the floating-point special-purpose unit is connected to the fixed-point output end of the fixed-point general-purpose unit. The fixed-point general-purpose unit completes the multiply accumulate calculation in the fixed-point arithmetic mode, and the fixed-point general-purpose unit and the floating-point special-purpose unit cooperate to complete the multiply accumulate calculation in the floating-point arithmetic mode, so that the same multiply accumulate module can implement both the fixed-point multiply accumulate operation and the floating-point multiply accumulate operation. Because the fixed-point operation unit and the floating-point operation unit are integrated in one circuit, and share some devices, a total quantity of devices used is reduced, thereby reducing an area occupied by the fixed-point operation unit and the floating-point operation unit on the chip, and reducing power consumption of the chip during multiply accumulate operation.

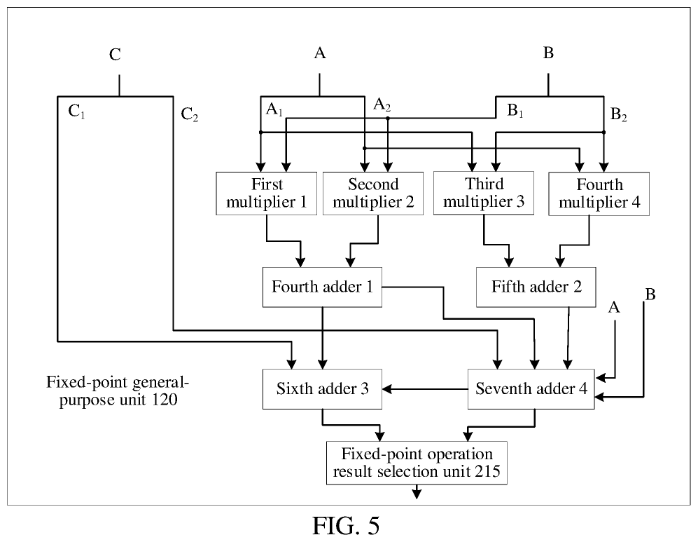

FIG. 5 is a schematic structural diagram of a fixed-point general-purpose unit 120 according to an example embodiment of this application. The fixed-point general-purpose unit 120 includes a first multiplier 1, a second multiplier 2, a third multiplier 3, a fourth multiplier 4, an adder 1, an adder 2, an adder 3, and a fixed-point operation result selection unit 215.

The first input end A is split into a first sub input end A1 and a first sub input end A2, and the second input end B is split into a second sub input end B1 and a second sub input end B2. The upper-level input end C is split into an upper-level sub input end C1 and an upper-level sub input end C2.

An input end of the first multiplier 1 is separately connected to the first sub input end A1 and the second sub input end B1. An input end of the second multiplier 2 is separately connected to the first sub input end A2 and the second sub input end B1. An input end of the third multiplier 3 is separately connected to the first sub input end A1 and the second sub input end B2. An input end of the fourth multiplier 4 is separately connected to the first sub input end A2 and the second sub input end B2.

An input end of the adder 1 is separately connected to an output end of the first multiplier 1 and an output end of the second multiplier 2. An input end of the adder 2 is separately connected to an output end of the third multiplier 3 and an output end of the fourth multiplier 4. An input end of the adder 3 is separately connected to an output end of the adder 1, an output end of the adder 4, and the upper-level sub input end C1. An input end of the adder 4 is separately connected to the output end of the adder 1, an output end of the adder 2, the upper-level sub input end C2, the first input end A, and the second input end B.

An input end of the fixed-point operation result selection unit 215 is separately connected to an output end of the adder 3 and the output end of the adder 4.

In one example, the first operand A, the second operand B, and the third operand C are all operands with a bit width of 16 bits. The first sub input end A1 is configured to input a front half [15:8] of the first operand A, that is, the 15^{th} bit to the 8^{th} bit. The 15^{th} bit is the leftmost bit, and the 0^{th} bit is the rightmost bit. The first sub input end A2 is configured to input a rear half [7:0] of the first operand A. The second sub input end B1 is configured to input a front half [15:8] of the second operand B, and the second sub input end B2 is configured to input a rear half [7:0] of the second operand B. The upper-level sub input end C1 is configured to input a front half [15:8] of the third operand C, and the upper-level sub input end C2 is configured to input a rear half [7:0] of the third operand C.

In the fixed-point arithmetic mode, the foregoing fixed-point general-purpose unit 120 is configured to: calculate a product of the first operand A and the second operand B, and then add the product and the third operand C.

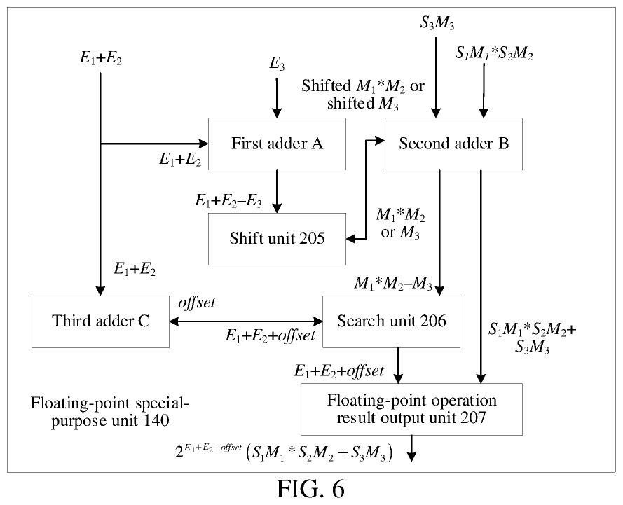

FIG. 6 is a schematic structural diagram of a floating-point special-purpose unit 140 according to an example embodiment of this application. The floating-point special-purpose unit 140 includes a first adder A, a second adder B, a third adder C, a shift unit 205, a search unit 206, and a floating-point operation result output unit 207.

An output end of the first adder A is separately connected to an output end of the fixed-point general-purpose unit 120 and the upper-level input end C. A third input end D of the second adder B is separately connected to the fixed-point output end of the fixed-point general-purpose unit 120, the upper-level input end C, and an output end of the shift unit 205. An input end of the third adder C is separately connected to the output end of the fixed-point general-purpose unit 120 and an output end of the search unit 206.

An input end of the shift unit 205 is separately connected to an output end of the first adder A and an output end of the second adder B. An input end of the search unit 206 is separately connected to an output end of the second adder B and an output end of the third adder C. The floating-point operation result output unit 207 is separately connected to the output end of the second adder B and the output end of the search unit 206.

When the arithmetic mode is the floating-point arithmetic mode, a first multiplication number S₁2^{E}^{₁}.M₁ is inputted to the multiply accumulate module from the first input end A, a second multiplication number S₂2^{E}^{₂}.M₂ is inputted to the multiply accumulate module from the second input end B, and a first addition number S₃2^{E}^{₃}.M₃ is inputted to the multiply accumulate module from the upper-level input end C. The floating-point special-purpose unit 140 performs floating-point operation, where calculation formulas are as follows:

E=E₁+E₂+offset, where the formula is a calculation formula of the exponent part;

M=S₁M₁*S₂M₂+S₃M₃, where the formula is a calculation formula of the decimal part; and

S2^{E}M=S₁2^{E}^{₁}M₁*S₂2^{E}^{₂}M₂+S₃2^{E}^{₃}M³=2^{E}^{₁}^{+E}^{₂}^{+offset}(S₁M₁*S₂M₂+S₃M₃), where the formula is a calculation formula of the floating-point operation result.

where E₁ is an exponent part of the first multiplication number, E₂ is an exponent part of the second multiplication number, and E₃ is an exponent part of the first addition number; S₁ is a sign bit of the first multiplication number, S₂ is a sign bit of the second multiplication number, and S₃ is a sign bit of the first addition number; M₁ is a decimal part of the first multiplication number, M₂ is a decimal part of the second multiplication number, and M₃ is a decimal part of the first addition number; and offset is a relative offset value of an exponent due to carry of a decimal result obtained through calculation.

In some embodiments, if an integer part of the first/second/third operand is a fixed value, and the integer part of the first/second/third operand may be removed when the first/second/third operand is represented, the integer part of the first/second/third operand further needs to be added to the highest bit in bits of a value before the floating-point arithmetic is performed, and is spliced with the decimal part M, to obtain an original first/second/third operand.

In some embodiments, if an exponent part of the first/second/third operand is an encoded value, the encoded value of the exponent part of the first/second/third operand needs to be decoded, and a value obtained through decoding is an original exponent part.

In one example, an encoding equation is E (actual)=E (encoded)−BIAS for decoding, where BIAS=15. When an encoded exponent part E (encoded) of an inputted first operand is 16, decoding is performed according to the encoding equation, to obtain an exponent part E (actual) of the first operand being 1.

In some embodiments, when the decimal part of the first/second/third operand includes an integer (including 0), an integer digit is added before the decimal part M during calculation of the decimal part M of the first/second/third operand.

In one example, when a value of the exponent part is 0, a decimal part of a corresponding actual value S*2^{E}* (0.M) includes an integer part 0, and when a value of the exponent part is non-0, a decimal part of a corresponding actual value S*2^{E}* (1.M) includes an integer part 1. In the foregoing two cases, when the decimal part 0.M and/or the decimal part 1.M are/is calculated, an integer digit needs to be added before the decimal part M, and operation is then performed.

The foregoing operation is performed by a corresponding calculation unit of the floating-point special-purpose unit 140, and a corresponding calculation execution process is as follows:

When the arithmetic mode is the floating-point arithmetic mode, the fixed-point general-purpose unit 120 is configured to: multiply a decimal part S₁M₁ of a first operand S₁2^{E}^{₁}.M₁ by a decimal part S₂M₂ of a second operand S₂ 2^{E}^{₂}.M₂, to obtain a first intermediate result S₁M₁*S₂M₂, and output the first intermediate result S₁M₁*S₂M₂ from the fixed-point output end, the decimal part carrying a sign bit; and is further configured to add an exponent part E₁ of the first operand S₁2^{E}^{₁}.M₁ and an exponent part E₂ of the second operand S₂2^{E}^{₂}.M₂, to obtain a first exponential sum E₁+E₂.

The first adder A is configured to add the first exponential sum E₁+E₂ and a negative value of an exponent part E₃ of a third operand S₃2^{E}^{₃}.M₃, to obtain a second exponential sum E₁+E₂−E₃.

The shift unit is configured to: obtain a shift object and a shift bit number according to the second exponential sum E₁+E₂−E₃, the shift object being the first intermediate result S₁M₁*S₂M₂ or a decimal part S₃M₃ of the third operand S₃2^{E}^{₃}.M₃; and shift the first intermediate result S₁M₁*S₂M₂ according to the shift bit number when the shift object is the first intermediate result S₁M₁*S₂M₂, to obtain a shifted first intermediate result; or shift the decimal part S₃M₃ of the third operand S₃2^{E}^{₃}.M₃ according to the shift bit number when the shift object is the decimal part S₃M₃ of the third operand S₃ 2^{E}^{₃}.M₃, to obtain a shifted decimal part of the third operand S₃ 2^{E}^{₃}.M₃.

The second adder B is configured to: add the shifted first intermediate result S₁M₁*S₂M₂ and the decimal part S₃M₃ of the third operand S₃2^{E}^{₃}.M₃ when the shift object is the first intermediate result S₁M₁*S₂M₂; or add the first intermediate result S₁M₁*S₂M₂ and the shifted decimal part of the third operand S₃2^{E}^{₃}.M₃ when the shift object is the decimal part S₃M₃ of the third operand S₃ 2^{E}^{₃}.M₃, to obtain a decimal sum.

The search unit is configured to: obtain, according to the decimal sum, a decimal result S₁M₁*S₂M₂+S₃M₃ and a relative offset value offset of an exponent obtained through calculation, and obtain an exponent result E₁+E₂+offset of the floating-point operation result from the third adder C.

The third adder C is configured to: add the relative offset value offset of the exponent and the first exponential sum E₁+E₂, to obtain the exponent result E₁+E₂+offset of the floating-point operation result.

The floating-point operation result output unit 207 is configured to: determine a sign bit of the floating-point operation result according to a sign bit of the decimal sum; and splice the sign bit of the floating-point operation result, the decimal result S₁M₁*S₂M₂+S₃M₃, and the exponent result E₁+E₂+offset together, to generate the floating-point operation result.

In some embodiments, when the first intermediate result is calculated by the fixed-point general-purpose unit 120, referring to FIG. 5, the decimal part S₁M₁ of the first operand and the decimal part S₂M₂ of the second operand S₂2^{E}^{₂}.M₂ are inputted to the first multiplier 1, the second multiplier 2, the third multiplier 3, or the multiplier 4 by using the first input end A and the second input end B respectively, a product of the decimal part S₁M₁ of the first operand S₁2^{E}^{₁}.M₁ and the decimal part S₂M₂ of the second operand S₂ 2^{E}^{₂}.M₂ is calculated by using the first multiplier 1, the second multiplier 2, the third multiplier 3, or the multiplier 4, and the first intermediate result is selected and outputted to the floating-point special-purpose unit 140 by using the fixed-point operation result selection unit.

In some embodiments, in the floating-point arithmetic mode, a first exponential sum of the exponent parts of the first operand S₁2^{E}^{₁}.M₁ and the second operand S₂2^{E}^{₂}.M₂ is calculated by using the adder 4 in the fixed-point general-purpose unit 120. Referring to FIG. 5, the exponent part E₁ of the first operand S₁2^{E}^{₁}.M₁ and the exponent part E₂ of the second operand S₂2^{E}^{₂}.M₂ are inputted to the adder 4 by using the first input end A and the second input end B respectively, and the first exponential sum E₁+E₂ is obtained through calculation by using the adder 4.

In summary, in the chip provided in this embodiment, by configuring the fixed-point general-purpose unit and the floating-point special-purpose unit in the multiply accumulate module, the floating-point special-purpose unit is connected to the fixed-point output end of the fixed-point general-purpose unit. The fixed-point general-purpose unit completes the multiply accumulate calculation in the fixed-point arithmetic mode, and the fixed-point general-purpose unit and the floating-point special-purpose unit cooperate to complete the multiply accumulate calculation in the floating-point arithmetic mode, so that the same multiply accumulate module can implement both the fixed-point multiply accumulate operation and the floating-point multiply accumulate operation. Because the fixed-point operation unit and the floating-point operation unit are integrated in one circuit, and share some devices, a total quantity of devices used is reduced, thereby reducing an area occupied by the fixed-point operation unit and the floating-point operation unit on the chip, and reducing power consumption of the chip during multiply accumulate operation.

The foregoing embodiments of FIG. 4 to FIG. 6 provide a multiply accumulate module that supports both the fixed-point operation and the floating-point operation. In an optional embodiment, the foregoing fixed-point general-purpose unit is further designed as a fixed-point general-purpose unit that supports a scalable design.

The scalability of the fixed-point general-purpose unit is embodied as follows: The same multiply accumulate operation module not only can support the integer multiplication operation of two high bit widths (such as 16 bits), but also is compatible with the integer multiplication operation of a plurality of groups of lower bit widths (such as 8 bits, 4 bits, and 2 bits).

In this embodiment, the same multiply accumulate module can support both characteristics:

First, a scalable fixed-point operation is supported.

Second, both the fixed-point operation and the floating-point operation are supported.

With this design, a highly multiplexed hardware circuit unit is provided, and multiplexes various multiplication operations and addition operations required in the scalable fixed-point operation and floating-point operation as a general-purpose calculation unit as more as possible, to maximally improve a multiplex ratio of a structure and save a hardware area.

If the first operand A and the second operand B are inputs of the multiply accumulate module, a bit width of input data is 2^{N}, where N=1, 2, 3 . . . . A splitting mode of the inputs is m, where m=2, 4, 8, and 16. In this case, a number k of groups is obtained by using the following formula:

k=2^{N}/m

Description is made by using an example in which N=4, and m=2. When DSP_MODE=0 supports two 16-bit multiply accumulate operations, DSP_MODE=1 is split into two groups of 8-bit multiply accumulate operations, and DSP_MODE=2 supports two 16-bit floating-point multiply accumulate operations.

Table 2 shows a structural diagram of input signals and output signals in the three arithmetic modes in this example. The three arithmetic modes include: a first fixed-point arithmetic mode (8-bit integer multiply accumulate operation), a second fixed-point arithmetic mode (16-bit integer multiply accumulate operation), and a floating-point arithmetic mode (16-bit floating-point multiply accumulate operation).

TABLE 2

| Type | Signal name | Function description |
|---|---|---|
| Input | A | DSP_MODE = 2, floating-point input |
| | | DSP_MODE = other, integer input |
| Input | B | DSP_MODE = 2, floating-point input |
| | | DSP_MODE = other, integer input |
| Input | C_IN | DSP_MODE = 2, floating-point input |
| | | DSP_MODE = other,integer input |
| Input | DSP_MODE | When DSP_MODE = 0, non-scalable integer |
| | | mode |
| | | When DSP_MODE = 1, scalable integer mode, |
| | | where a scaling coefficient is determined by m |
| | | When DSP_MODE = 2, floating-point mode |
| Output | C_OUT | When DSP_MODE = 0, non-scalable integer |
| | | mode |
| | | When DSP_MODE = 1, scalable integer mode, |
| | | where a scaling coefficient is determined by m |
| | | When DSP_MODE= 2, floating-point mode |

Description is made by using only 16 bits and 8 bits as an example. In different embodiments, possible designs with other numbers of bits, such as 128 bits, 64 bits, 32 bits, 16 bits, 8 bits, 4 bits, and 2 bits, may alternatively be used.

When supporting the scalable fixed-point operation, the foregoing multiply accumulate module 100 further includes a data recombiner 180. The first input end A and the second input end B are connected to the fixed-point general-purpose unit 120 by using the data recombiner 180. The data recombiner 180 is configured to recombine and/or split data of the first input end A and the second input end B.

Optionally, the fixed-point arithmetic mode includes the first fixed-point arithmetic mode and the second fixed-point arithmetic mode. The first fixed-point arithmetic mode is a fixed-point arithmetic mode for a low bit width k, and the second fixed-point arithmetic mode is a fixed-point arithmetic mode for a high bit width 2^{N}, where m is a divisor of 2^{N}.

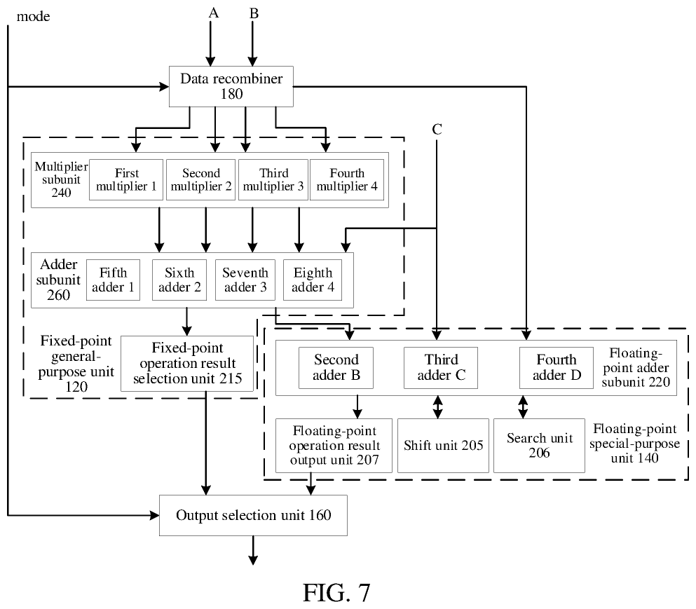

Referring to FIG. 7, the data recombiner 180 is configured to: recombine the first operand A from the first input end A and the second operand B from the second input end B into m groups of first suboperands A and m groups of second suboperands B respectively when the arithmetic mode is the first fixed-point arithmetic mode, a bit width k of the first/second suboperand=a first bit width 2^{N} of the first/second operand/m; and split the first operand A and the second operand B into k groups of fourth suboperands D and k groups of fifth suboperands E when the arithmetic mode is the second fixed-point arithmetic mode, a bit width k of the fourth/fifth suboperand=a second bit width 2^{N} of the fourth/fifth operand/m, the second bit width/the first bit width=2^{M}, m, k, and N being positive integers, and M being any positive integer less than N.

The fixed-point general-purpose unit 120 is further configured to: when the arithmetic mode is the first fixed-point arithmetic mode, multiply the k groups of first suboperands A by the k groups of second suboperands B, then respectively add k third suboperands C inputted by the upper-level input end C, and output a fixed-point operation result from the fixed-point output end.

The fixed-point general-purpose unit 120 is further configured to: when the arithmetic mode is the second fixed-point arithmetic mode, multiply the k groups of fourth suboperands D and the k groups of fifth suboperands E, then respectively add the k third suboperands C inputted by the upper-level input end C, and output the fixed-point operation result from the fixed-point output end.

When the arithmetic mode is the first fixed-point arithmetic mode, the first operand A and the second operand B may be combined into a first suboperand A₁ and a second suboperand B₁, and a first suboperand A₂ and a second suboperand B₂, then the first suboperand A₁/A₂ is multiplied by the second suboperand B₁/B₂, and added to the third suboperand C₁/C₂ respectively, and the foregoing operation result is outputted from the fixed-point output end.

When the arithmetic mode is the second fixed-point arithmetic mode, the first operand A and the second operand B may be split into a fourth suboperand D₁ and a fifth suboperand E₁, and a fourth suboperand D₂ and a fifth suboperand E₂, then the fourth suboperand D₁/D₂ is multiplied by the fifth suboperand E₁/E₂, and added to the third suboperand C₁/C₂ respectively, and the foregoing operation result is outputted from the fixed-point output end.

FIG. 7 is a structural block diagram of a multiply accumulate module according to an example embodiment of this application. The fixed-point general-purpose unit 120 includes a multiplier subunit 240, an adder subunit 260, and a fixed-point operation result selection unit 215.

An input end of the multiplier subunit 240 is connected to the data recombiner 180, an input end of the adder subunit 260 is separately connected to an output end of the multiplier subunit 240 and the upper-level input end C, an input end of the fixed-point operation result selection unit 215 is connected to an output end of the adder subunit 260, and an output end of the fixed-point operation result selection unit 215 is connected to the output selection unit 160.

The floating-point special-purpose unit 140 includes a floating-point adder subunit 220, a shift unit 205, a search unit 206, and a floating-point operation result output unit 207.

An input end of the floating-point adder subunit 220 is separately connected to the data recombiner 180, the upper-level input end C, the output end of the adder subunit 260, the shift unit 205, and the search unit 206, an input end of the shift unit 205 is connected to an output end of the floating-point adder subunit 220, an input end of the search unit 206 is connected to the output end of the floating-point adder subunit 220, an input end of the floating-point operation result output unit 207 is connected to the output end of the floating-point adder subunit 220, and an output end of the floating-point operation result output unit 207 is connected to the output selection unit 160.

Optionally, the data recombiner 180 includes k groups of recombination output ends, the i^{th} group of recombination output ends in the k groups of recombination output ends including a first recombination output end Aᵢ and a second recombination output end Bᵢ.

The fixed-point general-purpose unit includes

$$X = {( \frac{{2}^{N}}{h} )}^{2}$$

multipliers and

$$X = {( \frac{{2}^{N}}{h} )}^{2}$$

adders, h being a minimum value of the second bit width, and h and X being positive integers. A first input end of the j^{th} multiplier in the

$$X = {( \frac{{2}^{N}}{h} )}^{2}$$

multipliers is connected to a first recombination output end A_{f} in the f^{th} group of recombination output ends, and a second input end of the j^{th} multiplier is connected to a second recombination output end Bₜ in the t^{th} group of recombination output ends, f=j−(t−1)*m, t=ceil(j/m), ceil being rounding up, i and j being positive integers, and i being less than or equal to m.

Optionally, the j^{th} multiplier is configured to multiply the f^{th} group of suboperands A_{f}/D_{f} of the first operand A by the t^{th} group of suboperands Bₜ/Eₜ of the second operand B.

In one example, the data recombiner 180 includes two groups of recombination output ends. The two groups of recombination output ends include a first recombination output end A₁ and a second recombination output end B₁ in a first group of recombination output ends and a first recombination output end A₂ and a second recombination output end B₂ in a second group of recombination output ends. In this case, the fixed-point general-purpose unit 120 includes four multipliers and four adders. As shown in FIG. 7, the multiplier subunit 240 includes a first multiplier 1, a second multiplier 2, a third multiplier 3, and a fourth multiplier 4, and the adder subunit 260 includes a fourth adder 1, a fifth adder 2, a sixth adder 3, and a seventh adder 4.

In some embodiments, the structure of the fixed-point general-purpose unit 120 is shown in FIG. 7. The upper-level input end includes a first input end C₁ and a second input end C₂.

An input end of the first multiplier 1 is separately connected to the first recombination output end A₁ and the second recombination output end B₁, an input end of the second multiplier 2 is separately connected to the first recombination output end A₂ and the second recombination output end B₁, an input end of the third multiplier 3 is separately connected to the first recombination output end A₁ and the second recombination output end B₂, and an input end of the fourth multiplier 4 is separately connected to the first recombination output end A₂ and the second recombination output end B₂.

An input end of the fourth adder 1 is separately connected to an output end of the first multiplier 1 and an output end of the second multiplier 2, an input end of the fifth adder 2 is separately connected to an output end of the third multiplier 3, and an output end of the fourth multiplier 4, an input end of the sixth adder 3 is separately connected to an output end of the fourth adder 1, an output end of the fifth adder 4, and the first input end C₁, and an input end of the adder 4 is separately connected to the output end of the adder 1, the output end of the adder 2, and the second input end C₂, the first input end A, and the second input end.

An input end of the fixed-point operation result selection unit is separately connected to an output end of the adder 3 and the output end of the adder 4.

Optionally, the third operand C of the upper-level input end C includes two parts, namely, a third suboperand C₁ and a third suboperand C₂.

In some embodiments, the first multiplier 1 is configured to multiply data outputted by the first recombination output end A₁ by data outputted by the second recombination output end B₁, to obtain a first product; the second multiplier 2 is configured to multiply data outputted by the first recombination output end A₂ by the data outputted by the second recombination output end B₁, to obtain a second product; the third multiplier 3 is configured to multiply the data outputted by the first recombination output end A₁ by data outputted by the second recombination output end B₂, to obtain a third product; and the fourth multiplier 4 is configured to multiply the data outputted by the first recombination output end A₂ by the data outputted by the second recombination output end B₂, to obtain a fourth product.

The fourth adder 1 is configured to add the first product and the second product, to obtain a first addition sum. The fifth adder 2 is configured to add the third product and the fourth product, to obtain a second addition sum. The sixth adder 3 is configured to add the first addition sum, the third suboperand C₁, a carry value of the adder 4, to obtain a third addition sum. The adder 4 is configured to add the first addition sum, the second addition sum, and the third suboperand C₂, to obtain a fourth addition sum.

The fixed-point operation result selection unit 215 is configured to splice the third addition sum and the fourth addition sum together, to obtain the fixed-point operation result.

In some embodiments, the first multiplier 1 is configured to multiply data outputted by the first recombination output end A₁ by data outputted by the second recombination output end B₁, to obtain a first product; and the fourth multiplier 4 is configured to multiply data outputted by the first recombination output end A₂ by data outputted by the second recombination output end B₂, to obtain a fourth product.

The fourth adder 3 is configured to add the first product and the third suboperand C₁, to obtain a fifth addition sum. The seventh adder 4 is configured to add the fourth product and the third suboperand C₂, to obtain a sixth addition sum.

The fixed-point operation result selection unit 215 is configured to splice the fifth addition sum and the sixth addition sum together, to obtain the fixed-point output result.

In summary, in the chip including a multiply accumulate module provided in this embodiment, by configuring the fixed-point general-purpose unit and the floating-point special-purpose unit in the multiply accumulate module, the floating-point special-purpose unit is connected to the fixed-point output end of the fixed-point general-purpose unit. The fixed-point general-purpose unit completes the multiply accumulate calculation in the fixed-point arithmetic mode, and the fixed-point general-purpose unit and the floating-point special-purpose unit cooperate to complete the multiply accumulate calculation in the floating-point arithmetic mode, so that the same multiply accumulate module can implement both the fixed-point multiply accumulate operation and the floating-point multiply accumulate operation. Because the fixed-point operation unit and the floating-point operation unit are integrated in one circuit, and share some devices, a total quantity of devices used is reduced, thereby reducing an area occupied by the fixed-point operation unit and the floating-point operation unit on the chip, and reducing power consumption of the chip during multiply accumulate operation.

In the foregoing multiply accumulate module, four multipliers and seven adders may be used in one embodiment. Compared with that in the related technical solution, 10 multipliers and 12 adders are used for implementing the foregoing two fixed-point arithmetic modes and one floating-point arithmetic mode, five adders and six multipliers are reduced.

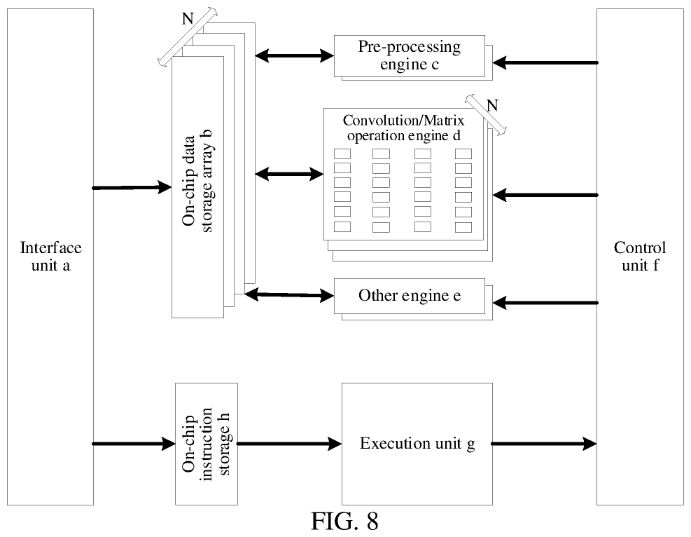

In some embodiments, any of the foregoing multiply accumulate modules is applicable to a neural network chip. FIG. 8 is a schematic structural diagram of a chip including a neural network model according to an example embodiment. The chip includes several systolic arrays, each systolic array including X*Y multiply accumulate modules.

For the same systolic array, a module output end of a multiply accumulate module in the i^{th} row and the j^{th} column is connected to an upper-level input end of a multiply accumulate module in the (i+1)^{th} row and the j^{th} column. Alternatively, for the same systolic array, a module output end of a multiply accumulate module in the i^{th} row and the j^{th} column is connected to an upper-level input end of a multiply accumulate module in the i^{th} row and a (j+1)^{th} column.

An input end of a multiply accumulate module in the i^{th} row and the j^{th} column of at least one systolic array in the systolic arrays is connected to an application layer, and an output end of a multiply accumulate module in the p^{th} row and the q^{th} column of the at least one systolic array is connected to the application layer. An output end of the multiply accumulate module in the p^{th} row and the q^{th} column of the at least one systolic array is an output end of the fixed-point operation result or the floating-point operation result, where i, j, p, q are positive integers.

In one example, the chip includes a 16*16 systolic array. An upper-level input end of a multiply accumulate module in the third row and the second column of the systolic array is connected to a module output end of a multiply accumulate module in the second row and the second column of the systolic array. Optionally, the upper-level input end of the multiply accumulate module in the third row and a second column of the systolic array may be further connected to a module output end of a multiply accumulate module in the third row and the first column of the systolic array.

As shown in FIG. 8, the chip including the neural network model includes an interface unit a, an on-chip data storage array b, a pre-processing engine c, a convolution/matrix operation engine d, an on-chip instruction storage h, an execution unit g, a control unit f, and another engine e. The convolution/matrix operation engine d is formed by a mesh including N layers of multiply accumulate modules, each layer including at least one multiply accumulate module, and N being a positive integer.

An input end of the on-chip data storage array b of the neural network chip is connected to the interface unit a, the pre-processing engine c, the convolution/matrix operation engine d, and the another engine e, and an output end is connected to the pre-processing engine c, the convolution/matrix operation engine d, and the another engine e. Input ends of the pre-processing engine c, the convolution/matrix operation engine d, and the another engine e are separately connected to the control unit f. An input end of the control unit f is connected to an output end of the execution unit g. An input end of the execution unit g is connected to an output end of the on-chip instruction storage h. An input end of the on-chip instruction storage h is connected to an output end of the interface unit a.

The interface unit a is configured for data input. The on-chip data storage array b is configured for temporary storage of the intermediate results. The pre-processing engine c is configured to pre-process the data. The convolution/matrix operation engine d is configured for operation on the data. The on-chip instruction storage h is configured to store instructions. The execution unit g is configured to load and execute the instructions. The control unit f is configured to control the engine to process the data. The another engine e is configured to perform other operations.

Optionally, the foregoing multiply accumulate module is integrated in the chip. The foregoing chip is any one of a CPU, a GPU, an FPGA, an ASIC, or another AI chip.

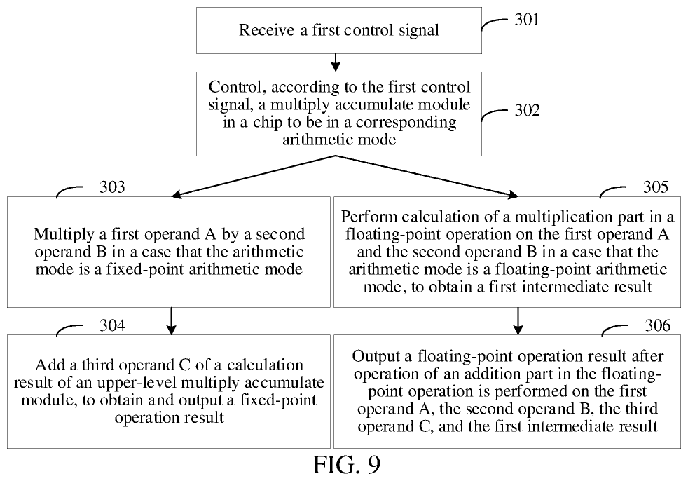

FIG. 9 is a flowchart of a control method according to an example embodiment of this application. The method is applicable to any chip shown in FIG. 4 to FIG. 8. The foregoing chip includes a multiply accumulate module. The method includes the following steps:

Step 301. Receive a first control signal.

The multiply accumulate module includes a mode selection end. The mode selection end is configured to select a fixed-point arithmetic mode or a floating-point arithmetic mode. The multiply accumulate module receives the first control signal by using the mode selection end. The first control signal includes arithmetic mode information. For example, the first control signal is represented by a two-digit binary number, the fixed-point arithmetic mode is represented by “00”, and the floating-point arithmetic mode is represented by “10”.

Step 302. Control, according to the first control signal, a multiply accumulate module in the chip to be in a corresponding arithmetic mode.

The multiply accumulate module includes a fixed-point general-purpose unit and a floating-point special-purpose unit. The multiply accumulate module makes, according to the arithmetic mode information in the first control signal, a circuit of the fixed-point general-purpose unit or the floating-point special-purpose unit connected.

When the circuit of the fixed-point general-purpose unit is connected, the multiply accumulate module is in the fixed-point arithmetic mode. When the circuit of the floating-point special-purpose unit is connected, the multiply accumulate module is in the floating-point arithmetic mode.

Step 303 is performed when the multiply accumulate module is in the fixed-point arithmetic mode. Step 305 is performed when the multiply accumulate module is in the floating-point arithmetic mode.

For example, the fixed-point arithmetic mode is represented by “00” in binary, and the floating-point arithmetic mode is represented by “10” in binary. When the first control signal is “00”, a circuit in the multiply accumulate module corresponding to the fixed-point arithmetic mode is connected, and step 303 is performed. When the first control signal is “10”, a circuit in the multiply accumulate module corresponding to the floating-point arithmetic mode is connected, and step 305 is performed.

Step 303. Multiply a first operand A by a second operand B when the arithmetic mode is the fixed-point arithmetic mode.

The multiply accumulate module includes: a first input end and a second input end configured to input multiplication numbers, and an upper-level input end configured to input an addition number. When the arithmetic mode is the fixed-point arithmetic mode, the multiply accumulate module multiplies, by using the multiplier, the first operand A inputted from the first input end and the second operand B inputted from the second input end.

Step 304. Add a third operand C of a calculation result of an upper-level multiply accumulate module, to obtain and output a fixed-point operation result.

The multiply accumulate module adds, by using the adder, a product of the first operand A and the second operand B and the third operand C inputted from the upper-level input end, to obtain the fixed-point operation result, the fixed-point operation result being a final operation result; and outputs the fixed-point operation result.

Step 305. Perform calculation of a multiplication part in a floating-point operation on the first operand A and the second operand B when the arithmetic mode is the floating-point arithmetic mode, to obtain a first intermediate result.

The floating-point special-purpose unit and the fixed-point general-purpose unit share the multiplier. When the arithmetic mode is the floating-point arithmetic mode, the multiply accumulate module multiplies the decimal part of the first operand A by the decimal part of the second operand B by using the multiplier in the fixed-point general-purpose unit, to obtain a first intermediate result through calculation.

Step 306. Output a floating-point operation result after operation of an addition part in the floating-point operation is performed on the first operand A, the second operand B, the third operand C, and the first intermediate result.

The multiply accumulate module performs an addition operation on the exponent parts of the first operand A, the second operand B, and the third operand C by using the adder in the floating-point special-purpose unit, and performs an addition operation on the decimal part of the third operand C and the first intermediate result. The floating-point operation result output unit of the multiply accumulate module combines results of the addition operations of the exponent parts and the decimal parts, to obtain and output the floating-point operation result.

The control method provided in this embodiment includes: receiving a first control signal; controlling, according to the first control signal, a multiply accumulate module in the chip to be in a corresponding arithmetic mode; performing a fixed-point operation when the arithmetic mode of the multiply accumulate module is the fixed-point arithmetic mode; and performing a floating-point operation when the arithmetic mode of the multiply accumulate module is the floating-point arithmetic mode. The method implements the compatibility between the fixed-point operation and the floating-point operation in a circuit. Because the fixed-point operation unit and the floating-point operation unit are integrated in one circuit, and share the multiplier, a total quantity of devices used is reduced, thereby reducing an area occupied by the fixed-point operation unit and the floating-point operation unit on the chip and power consumption during operation.

When the arithmetic mode of the multiply accumulate module is the floating-point arithmetic mode, a first multiplication number S₁2^{E}^{₁}.M₁ is inputted to the multiply accumulate module from the first input end A, a second multiplication number S₂2^{E}^{₂}.M₂ is inputted to the multiply accumulate module from the second input end B, and a first addition number S₃2^{E}^{₃}.M₃ is inputted to the multiply accumulate module from the upper-level input end C. The floating-point special-purpose unit 140 performs floating-point operation, where calculation formulas are as follows:

E=E₁+E₂+offset, where the formula is a calculation formula of the exponent part;

M=S₁M₁*S₂M₂+S₃M₃, where the formula is a calculation formula of the decimal part; and

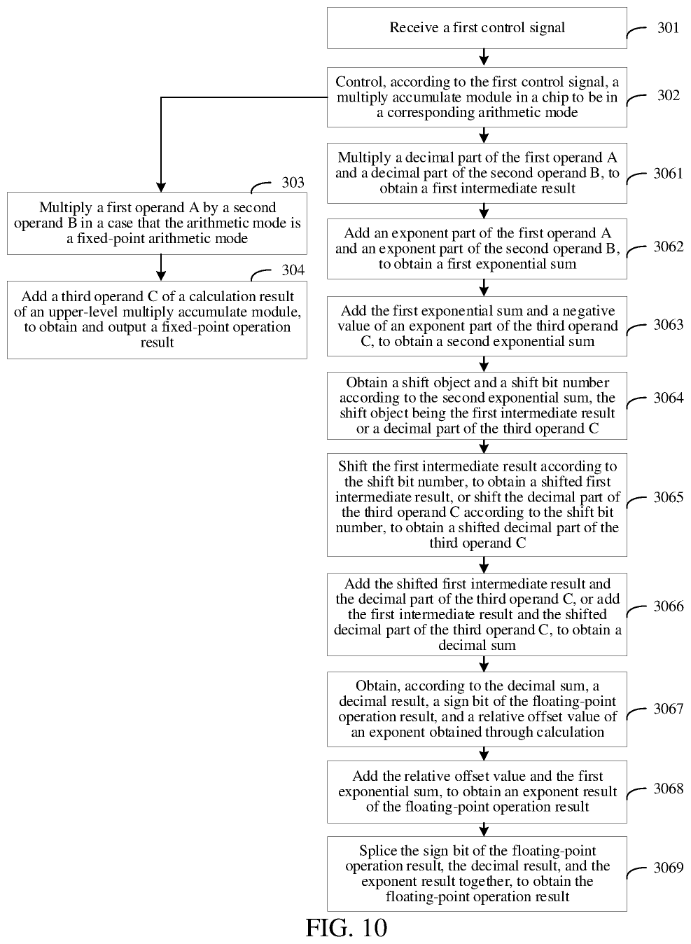

S2^{E}M=S₁2^{E}^{₁}M₁*S₂2^{E}^{₂}M₂+S₃2^{E}^{₃}M₃=2^{E}^{₁}^{+E}^{₂}^{+offset}(S₁M₁*S₂M₂+S₃M₃), where the formula is a calculation formula of the floating-point operation result,

where E₁ is an exponent part of the first multiplication number, E₂ is an exponent part of the second multiplication number, and E₃ is an exponent part of the first addition number; S₁ is a sign bit of the first multiplication number, S₂ is a sign bit of the second multiplication number, and S₃ is a sign bit of the first addition number; M₁ is a decimal part of the first multiplication number, M₂ is a decimal part of the second multiplication number, and M₃ is a decimal part of the first addition number; and offset is a relative offset value of an exponent due to carry of a decimal result obtained through calculation. Referring to FIG. 10, step 305 and step 306 in FIG. 9 may be replaced with step 3061 to step 3069. Description is made in detail when the arithmetic mode is the floating-point arithmetic mode, and steps are as follows:

Step 3061. Multiply a decimal part of the first operand A and a decimal part of the second operand B, to obtain a first intermediate result.

Correspondingly, the first operand A is a first multiplication number S₁2^{E}^{₁}.M₁, the second operand B is a second multiplication number S₂2^{E}^{₂}.M₂, and the third operand C is a first addition number S₃2^{E}^{₃}.M₃.

The floating-point special-purpose unit and the fixed-point general-purpose unit share the multiplier. The multiply accumulate module multiplies the decimal part S₁M₁ of the first operand S₁2^{E}^{₁}.M₁ by the decimal part S₂M₂ of the second operand S₂2^{E}^{₂}.M₂ by using the multiplier in the fixed-point general-purpose unit, to obtain the first intermediate result S₁M₁*S₂M₂.

Step 3062. Add an exponent part of the first operand A and an exponent part of the second operand B, to obtain a first exponential sum.

The multiply accumulate module further adds the exponent part E₁ of the first operand S₁2^{E}^{₁}.M₁ and the exponent part E₂ of the second operand S₂2^{E}^{₂}.M₂ by using the adder in the fixed-point general-purpose unit, to obtain the first exponential sum E₁+E₂.

Step 3063. Add the first exponential sum and a negative value of an exponent part of the third operand C, to obtain a second exponential sum.

The multiply accumulate module adds the first exponential sum E₁+E₂ and a negative value −E₃ of an exponent part of a third operand S₃2^{E}^{₃}.M₃ by using the adder in the floating-point special-purpose unit, to obtain a second exponential sum E₁+E₂−E₃.

Step 3064. Obtain a shift object and a shift bit number according to the second exponential sum, the shift object being the first intermediate result or a decimal part of the third operand C.

The multiply accumulate module performs data processing on the second exponential sum E₁+E₂−E₃. by using the shift unit, to obtain a shift object and a shift bit number of the shift object.

Step 3065. Shift the first intermediate result according to the shift bit number, to obtain a shifted first intermediate result, or shift the decimal part of the third operand C according to the shift bit number, to obtain a shifted decimal part of the third operand C.

The first intermediate result S₁M₁*S₂M₂ is shifted according to the shift bit number when the shift object is the first intermediate result S₁M₁*S₂M₂, to obtain a shifted first intermediate result; or the decimal part S₃M₃ of the third operand S₃2^{E}^{₃}.M₃ is shifted according to the shift bit number when the shift object is the decimal part S₃M₃ of the third operand S₃2^{E}^{₃}.M₃, to obtain a shifted decimal part of the third operand S₃2^{E}^{₃}.M₃.

Step 3066. Add the shifted first intermediate result and the decimal part of the third operand C, or add the first intermediate result and the shifted decimal part of the third operand C, to obtain a decimal sum.

The shifted first intermediate result S₁M₁*S₂M₂ and the decimal part S₃M₃ of the third operand S₃2^{E}^{₃}.M₃ are added when the shift object is the first intermediate result S₁M₁*S₂M₂; or the first intermediate result S₁M₁*S₂M₂ and the shifted decimal part of the third operand S₃2^{E}^{₃}.M₃ are added when the shift object is the decimal part S₃M₃ of the third operand S₃2^{E}^{₃}.M₃, to obtain a decimal sum.

Step 3067. Obtain, according to the decimal sum, a decimal result, a sign bit of the floating-point operation result, and a relative offset value of an exponent obtained through calculation.

A decimal result S₁M₁*S₂M₂+S₃M₃ and a relative offset value offset of an exponent obtained through calculation are obtained according to the decimal sum.

The multiply accumulate module performs data processing on the decimal sum by using the search unit, to obtain the decimal result and the relative offset value offset of the exponent, and obtains the sign bit of the decimal sum as the sign bit of the floating-point operation result by using the floating-point operation result output unit.

Step 3068. Add the relative offset value and the first exponential sum, to obtain an exponent result of the floating-point operation result.

The multiply accumulate module adds the relative offset value offset of the exponent and the first exponential sum E₁+E₂ by using the adder, to obtain the exponent result of the floating-point operation result, and updates the added result to the exponent result by using the search unit, to obtain the final exponent result E₁+E₂+offset of the floating-point operation result.

Step 3069. Splice the sign bit of the floating-point operation result, the decimal result, and the exponent result together, to obtain the floating-point operation result.

The multiply accumulate module splices the sign bit of the floating-point operation result, the decimal result, and the exponent result together by using the floating-point operation result output unit, to obtain the floating-point operation result.

In summary, the control method provided in this embodiment includes: receiving a first control signal; controlling, according to the first control signal, a multiply accumulate module in the chip to be in a corresponding arithmetic mode; performing a fixed-point operation when the arithmetic mode of the multiply accumulate module is the fixed-point arithmetic mode; and performing a floating-point operation when the arithmetic mode of the multiply accumulate module is the floating-point arithmetic mode. The method implements the compatibility between the fixed-point operation and the floating-point operation in a circuit. Because the fixed-point operation unit and the floating-point operation unit are integrated in one circuit, and share the multiplier, a total quantity of devices used is reduced, thereby reducing an area occupied by the fixed-point operation unit and the floating-point operation unit on the chip and power consumption during operation.

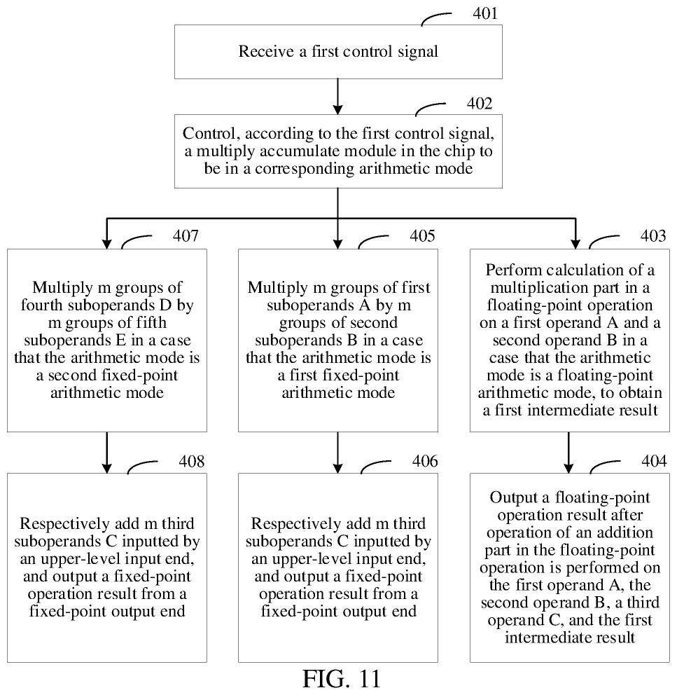

When the control method of the multiply accumulate module is the fixed-point arithmetic mode, the fixed-point arithmetic mode includes a first fixed-point arithmetic mode and a second fixed-point arithmetic mode. FIG. 11 describes the multiply accumulate module of which the fixed-point arithmetic mode includes the first fixed-point arithmetic mode and the second fixed-point arithmetic mode, and an example in which the first fixed-point arithmetic mode is an 8-bit width fixed-point arithmetic mode and the second fixed-point arithmetic mode is a 16-bit width fixed-point arithmetic mode is used.

Step 401. Receive a first control signal.

The multiply accumulate module includes a mode selection end. The mode selection end is configured to select a first fixed-point arithmetic mode or a second fixed-point arithmetic mode, or the floating-point arithmetic mode as the arithmetic mode of the multiply accumulate module. The multiply accumulate module receives the first control signal by using the mode selection end. The first control signal includes arithmetic mode information. For example, the first control signal is represented by a two-digit binary number, the first fixed-point arithmetic mode is represented by “00”, the second fixed-point arithmetic mode is represented by “01”, and the floating-point arithmetic mode is represented by “10”.

Step 402. Control, according to the first control signal, a multiply accumulate module in the chip to be in a corresponding arithmetic mode.

The multiply accumulate module includes a fixed-point general-purpose unit and a floating-point special-purpose unit. The multiply accumulate module is connected to a circuit of the fixed-point general-purpose unit or the floating-point special-purpose unit according to the arithmetic mode information in the first control signal.

When the circuit of the fixed-point general-purpose unit is connected, the multiply accumulate module is in the fixed-point arithmetic mode. When the circuit of the floating-point special-purpose unit is connected, the multiply accumulate module is in the floating-point arithmetic mode.

In one example, when an electrical signal received by the mode selection end is “00”, the multiply accumulate module is in the first fixed-point arithmetic mode. When the electrical signal received by the mode selection end is “01”, the multiply accumulate module is in the second fixed-point arithmetic mode. When the electrical signal received by the mode selection end is “10”, the multiply accumulate module is in the floating-point arithmetic mode.

The selection of the arithmetic modes of the multiply accumulate module is determined according to requirements of operation of a program in the application layer of the electronic device.

Step 403. Perform calculation of a multiplication part in a floating-point operation on a first operand A and a second operand B when the arithmetic mode is the floating-point arithmetic mode, to obtain a first intermediate result.

Referring to step 305 in FIG. 9, details were already described herein.

Step 404. Output a floating-point operation result after operation of an addition part in the floating-point operation is performed on the first operand A, the second operand B, a third operand C, and the first intermediate result.

Referring to step 306 in FIG. 9, details were already described herein.

Step 405. Multiply m groups of first suboperands A by m groups of second suboperands B when the arithmetic mode is the first fixed-point arithmetic mode.

When the arithmetic mode is the first fixed-point arithmetic mode, the data recombiner of the multiply accumulate module recombines the first operand A from the first input end and the second operand B from the second input end into the m groups of first suboperands A and the m groups of second suboperands B respectively, a bit width k of the first/second suboperand=a first bit width 2^{N} of the first/second operand/m; and multiplies the m groups of first suboperands A by the m groups of second suboperands B by using the multiplier, m and N being positive integers.

A first bit width in the first fixed-point arithmetic mode is less than the maximum bit width of the operand that can be calculated in the fixed-point arithmetic mode. The maximum bit width is the second bit width, the second bit width/the first bit width=2^{M}, and M being any positive integer less than N.

Step 406. Respectively add m third suboperands C inputted by an upper-level input end, and output a fixed-point operation result from a fixed-point output end.

The multiply accumulate module respectively adds, by using the adder, results of multiplying the m groups of first suboperands A by the m groups of second suboperands B and the m third suboperands C inputted by the upper-level input end, to obtain a final fixed-point operation result, and outputs the fixed-point operation result by using the fixed-point operation result selection unit.

In one example, when m is 2, the third operand C includes two parts, namely, a third suboperand C₁ and a third suboperand C₂. When the arithmetic mode is the first fixed-point arithmetic mode, the first operand A after being recombined includes a first suboperand A₁ and a first suboperand A₂, and the second operand B after being recombined includes a second suboperand B₁ and a second suboperand B₂. The operation process of step 405 and step 406 may be as follows:

The multiply accumulate module multiplies the first suboperand A₁ by the second suboperand B₁ by using the first multiplier 1, to obtain a first product; multiplies the first suboperand A₂ and the second suboperand B₂ by using the fourth multiplier 4, to obtain a fourth product; adds the first product and the third suboperand C₁ by using the fourth adder 1, to obtain a fifth addition sum; adds the fourth product and the third suboperand C₂ by using the seventh adder 4, to obtain a sixth addition sum; and splices the fifth addition sum and the sixth addition sum together by using the fixed-point operation result selection unit, to obtain a fixed-point operation result, and outputs the fixed-point operation result.

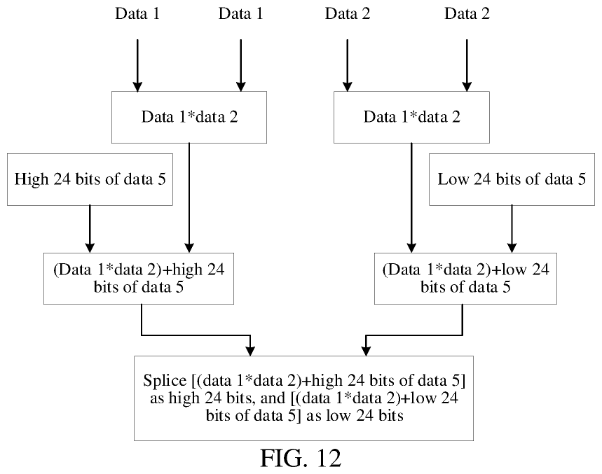

For example, in a data stream shown in FIG. 12, if a data bit width of an operand in the second fixed-point arithmetic mode is 16 bits, and m is 2, a data bit width of an operand in the first fixed-point arithmetic mode is 8 bits. An 8-bit operand 1 and an 8-bit operand 2 are inputted at the first input end and the second input end, and 48-bit data 3 is inputted at the upper-level input end. After data 1 is recombined by using the data recombiner, two pieces of data 1 are spliced into one piece of 16-bit data 11, and both high 8 bits and low 8 bits of data 11 are the data 1. Similarly, pieces of data 2 are spliced into one piece of 16-bit data 22, and both high 8 bits and low 8 bits of the data 22 are the data 2. In this case, data 5 is split into high 24 bits and low 24 bits.

The multiplier 1 multiplies the high 8 bits of the data 11 by the high 8 bits of the data 22, to obtain a first product “data 1*data 2” with a bit width of 16 bits. The multiplier 4 multiplies the low 8 bits of the data 11 by the low 8 bits of the data 22, to obtain a second product “data 1*data 2” with a bit width of 16 bits.

The adder 1 adds the first product and the high 24 bits of the data 5, to obtain a 24-bit fifth addition sum “(data 1*data 2)+high 24 bits of data 5”. The adder 3 adds the fourth product and the low 24 bits of the data 5, to obtain a 24-bit sixth addition sum “(data 1*data 2)+low 24 bits of data 5”.

The fixed-point selection unit splices the fifth addition sum and the sixth addition sum into the high 24 bits and the low 24 bits respectively, to obtain a 48-bit fixed-point operation result, and outputs the fixed-point operation result.

The data stream in the foregoing process is represented as follows:

SIZE=16, where a bit width of the operand is 16 bits;

SUB_PART_SIZE=8, where a bit width of the suboperands is 8 bits;

SUB_PART_NUMBER=SIZE/SUB_PART_SIZE, where a group number is a bit width of the operand, namely, 16 bits/a bit width of the suboperand, namely, 8 bits, that is, 2.

SUB_PART_H=RANGE(SIZE_PART_NUMBER*SUB_PART_SIZE−1,SUB_PART_SIZE), where the high 8 bits are represented by [15:8];

SUB_PART_L=RANGE(SUB_PART_SIZE−1,0), where the low 8 bits are represented by [7:0];

A1=unpack(A,SUB_PART_H), where A1 is the high 8 bits;

A0=unpack(A,SUB_PART_L), where A0 is the low 8 bits;

B1=unpack(B,SUB_PART_H), where B1 is the high 8 bits;

B0=unpack(B,SUB_PART_L), where B0 is the low 8 bits;

C1=C_IN_H, where C1 is the high 24 bits;

C0=C_IN_L, where C0 is the low 24 bits;

C_OUT_H=A1*B1+C_IN_H, where C_OUT_H is a calculation result of the high 24 bits; and

C_OUT_L=A0*B0+C_IN_L, where C_OUT_L is a calculation result of the low 24 bits.

Step 407. Multiply m groups of fourth suboperands D by m groups of fifth suboperands E when the arithmetic mode is the second fixed-point arithmetic mode.

When the arithmetic mode is the second fixed-point arithmetic mode, the data recombiner in the multiply accumulate module splits the first operand A and the second operand B into m groups of fourth suboperands D and m groups of fifth suboperands E, a bit width k of the fourth/fifth suboperand=a second bit width 2^{N} of the fourth/fifth operand/m; and multiplies the m groups of fourth suboperands D by the m groups of fifth suboperands E by using the multiplier.

Step 408. Respectively add m third suboperands C inputted by an upper-level input end, and output a fixed-point operation result from a fixed-point output end.

The multiply accumulate module respectively adds, by using the adder, results of multiplying the m groups of fourth suboperands D by the m groups of fifth suboperands E and the m third suboperands C inputted by the upper-level input end, to obtain a final fixed-point operation result, and outputs the fixed-point operation result by using the fixed-point operation result selection unit.

In one example, when m is 2, the third operand C includes two parts, namely, a third suboperand C₁ and a third suboperand C₂. When the arithmetic mode is the second fixed-point arithmetic mode, the first operand A after being split includes a fourth suboperand D₁ and a fourth suboperand D₂, and the second operand B after being split includes a fifth suboperand E₁ and a fifth suboperand E₂. The operation process of step 407 and step 408 may be as follows:

The multiply accumulate module multiplies the fourth suboperand D₁ and the fifth suboperand E₁ by using the first multiplier 1, to obtain a first product; multiplies the fourth suboperand D₂ and the fifth suboperand E₁ by using the second multiplier 2, to obtain a second product; multiplies the fourth suboperand D₁ and the fifth suboperand E₂ by using the third multiplier 3, to obtain a third product; multiplies the fourth suboperand D₂ and the fifth suboperand E₂ by using the fourth multiplier 4, to obtain a fourth product; adds the first product and the second product by using the fourth adder 1, to obtain a first addition sum; adds the third product and the fourth product by using the fifth adder 2, to obtain a second addition sum; adds the first addition sum, the second addition sum, the third suboperand C₁, a carry value of the adder 4 by using the sixth adder 3, to obtain a third addition sum; adds the first addition sum, the second addition sum, and the third suboperand C₂ by using the seventh adder 4, to obtain a fourth addition sum; and splices the third addition sum and the fourth addition sum together by using the fixed-point operation result selection unit, to obtain the fixed-point operation result.

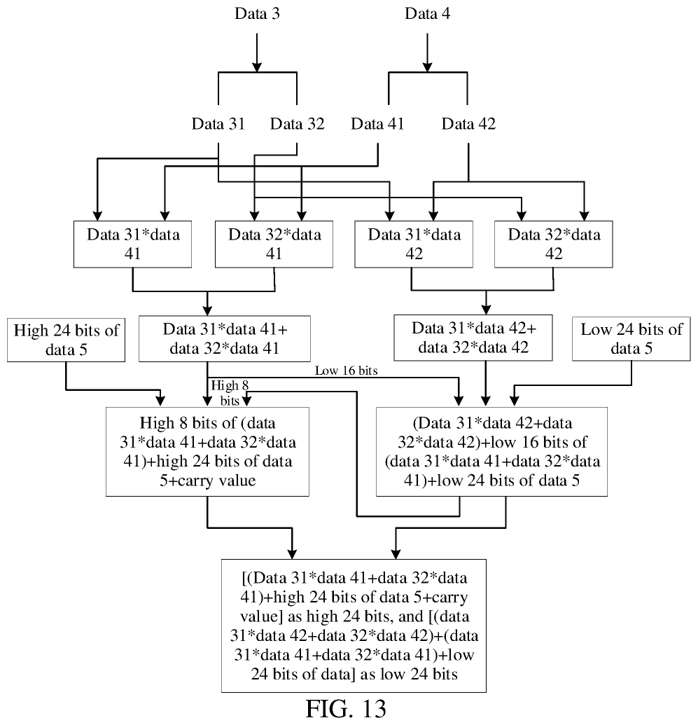

For example, in a data stream shown in FIG. 13, a data bit width of an operand in the second fixed-point arithmetic mode is 16 bits, and m is 2. A 16-bit operand 3 and a 16-bit operand 4 are inputted at the first input end and the second input end, and 48-bit data 3 is inputted at the upper-level input end. After the data 1 is split by using the data recombiner, the data 1 is split into 8-bit data 31 and 8-bit data 32, the data 31 is the high 8 bits of the data 3, and the data 32 is the low 8 bits of the data 3. Similarly, the data 4 is split into 8-bit data 41 and 8-bit data 42, the data 41 is the high 8 bits of the data 4, and the data 42 is the low 8 bits of the data 4. In this case, data 5 is split into high 24 bits and low 24 bits.

The multiplier 1 multiplies the data 31 by the data 41, to obtain a first product “data 31*data 41” with a bit width of 16 bits. The multiplier 2 multiplies the data 32 by the data 41, to obtain a second product “data 32*data 41” with a bit width of 16 bits. The multiplier 3 multiplies the data 31 by the data 42, to obtain a third product “data 31*data 42” with a bit width of 16 bits. The multiplier 4 multiplies the data 32 by the data 42, to obtain a fourth product “data 32*data 42” with a bit width of 16 bits.

The adder 1 adds the first product “data 31*data 41” and the second product “data 32*data 41”, to obtain a first addition sum “data 31*data 41+data 32*data 41” with a bit width of 24 bits. The adder 2 adds the third product “data 31*data 42” and the fourth product “data 32*data 42”, to obtain a second addition sum “data 31*data 42+data 32*data 42” with a bit width of 16 bits. The adder 3 adds high 8 bits of the first addition sum, the high 24 bits of the data 5, and the carry value of the adder 4, to obtain a third addition sum with a bit width of 24 bits, and the adder 4 adds low 16 bits of the first addition sum, the second addition sum, and the low 24 bits of the data 5, to obtain a fourth addition sum “(data 31*data 42+data 32*data 42)+(data 31*data 41+data 32*data 41)+low 24 bits of data 5” with a bit width of 24 bits. The fourth addition sum and the third addition sum with the bit width of 24 bits are spiced together by using the fixed-point operation result selection unit, and outputs a fixed-point operation result with a bit width of 48 bits.

The data stream in the foregoing process is represented as follows:

SIZE=16, where a bit width of the operand is 16 bits;

SUB_PART_SIZE=8, where a bit width of the suboperands is 8 bits;

SUB_PART_NUMBER=SIZE/SUB_PART_SIZE, where a group number is a bit width of the operand, namely, 16 bits/a bit width of the suboperand, namely, 8 bits, that is, 2.

SUB_PART_H=RANGE(SIZE_PART_NUMBER*SUB_PART_SIZE−1,SUB_PART_SIZE), where the high 8 bits are represented by [15:8];

SUB_PART_L=RANGE(SUB_PART_SIZE−1,0), where the low 8 bits are represented by [7:0];

A1=unpack(A,SUB_PART_H), where A1 is the high 8 bits;

A0=unpack(A,SUB_PART_L), where A0 is the low 8 bits;

B1=unpack(B,SUB_PART_H), where B1 is the high 8 bits;

B0=unpack(B,SUB_PART_L), where B0 is the low 8 bits;

C1=C_IN_H, where C1 is the high 24 bits;

C0=C_IN_L, where C0 is the low 24 bits;

ADD1=shift(A1*B1,SUB_PART)+A0B1, indicating a first addition sum of the first product and the second product;

ADD2=shift(A1*B0,SUB_PART)+A0B0, indicating a second addition sum of the third product and the fourth product;

ADD3=C_IN_L+ADD2+ADD1_L, indicating a fourth addition sum of the first addition sum, the second addition sum, and low 24 bits of upper-level addition numbers;

ADD4=carry(ADD3)+ADD1_H+C_IN_H, indicating a third addition sum of the first addition sum, high 24 bits of upper-level addition numbers, and a carry value of the third addition sum;

C_OUT_H=ADD4, where the third addition sum is a calculation result of the high 24 bits; and

C_OUT_L=ADD3, where the fourth addition sum is a calculation result of the low 24 bits.

In summary, the control method provided in this embodiment includes: receiving a first control signal; controlling, according to the first control signal, a multiply accumulate module in the chip to be in a corresponding arithmetic mode; performing a fixed-point operation when the arithmetic mode of the multiply accumulate module is the fixed-point arithmetic mode; and performing a floating-point operation when the arithmetic mode of the multiply accumulate module is the floating-point arithmetic mode. The method implements the compatibility between the fixed-point operation and the floating-point operation in a circuit. Because the fixed-point operation unit and the floating-point operation unit are integrated in one circuit, and share the multiplier, a total quantity of devices used is reduced, thereby reducing an area occupied by the fixed-point operation unit and the floating-point operation unit on the chip and power consumption during operation.

In the control method provided in this embodiment, the integer multiplication operation of a plurality of groups of lower bit widths is further compatible, while the integer multiplication operation of two high bit widths is supported in one circuit, thereby reducing a total quantity of devices used in the circuit when the integer multiplication operation of different bit widths is supported simultaneously, and reducing an area occupied by the fixed-point operation unit on the chip and power consumption during operation.

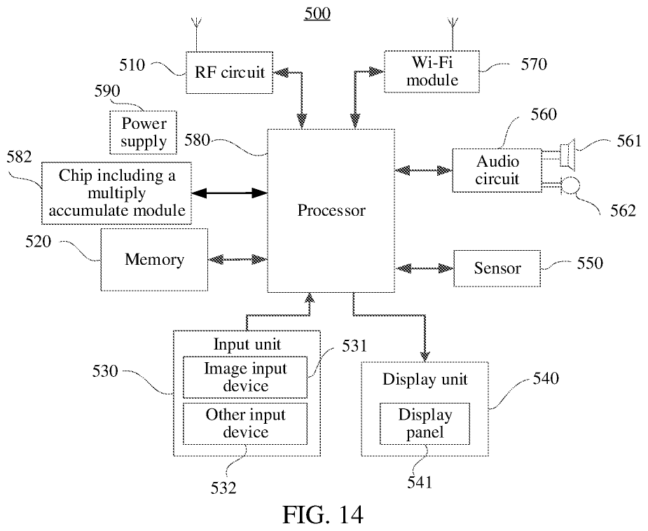

FIG. 14 is a schematic structural diagram of an electronic device according to an embodiment of this application. The electronic device is configured to implement the control method provided in the foregoing embodiments. Optionally, the electronic device includes at least one of a smartphone, a server, an Internet of Things (IoT) device, a cloud server, and an edge-side device.

The electronic device 500 may include components such as a radio frequency (RF) circuit 510, a memory 520 including one or more computer-readable storage media, an input unit 530, a display unit 540, a sensor 550, an audio circuit 560, a wireless fidelity (Wi-Fi) module 570, a processor 580 including one or more processing cores, and a power supply 590. A person skilled in the art may understand that the electronic device structure shown in FIG. 14 does not constitute a limitation to the electronic device. The electronic device may include more or fewer components than those shown in the figure, may combine some components, or may have different component arrangements.

The RF circuit 510 may be configured to receive and transmit signals during an information receiving and transmitting process or a call process. Particularly, after receiving downlink information from a base station, the RF circuit delivers the downlink information to one or more processors 580 for processing, and transmits related uplink data to the base station. Generally, the RF circuit 510 includes, but not limited to, an antenna, at least one amplifier, a tuner, one or more oscillators, a subscriber identity module (SIM) card, a transceiver, a coupler, a low noise amplifier (LNA), and a duplexer. In addition, the RF circuit 510 may also communicate with a network and another device through wireless communication. The wireless communication may use any communication standard or protocol, which includes, but not limited to, Global system for mobile communication (GSM), general packet radio service (GPRS), Code Division Multiple Access (CDMA), Wideband Code Division Multiple Access (WCDMA), Long Term Evolution (LTE), email, short messaging service (SMS), and the like.

The memory 520 may be configured to store a software program and module. The processor 580 runs the software program and module stored in the memory 520, to implement various functional applications and data processing. The memory 520 may mainly include a program storage area and a data storage area. The program storage area may store an operating system, an application program required by at least one function (for example, a sound playback function and an image playback function), or the like. The data storage area may store data (for example, audio data and a telephone book) and the like created according to use of the electronic device 500. In addition, the memory 520 may include a high speed random access memory, and may also include a non-volatile memory, such as at least one magnetic disk storage device, a flash memory, or another volatile solid-state storage device. Correspondingly, the memory 520 may further include a memory controller, so as to provide access of the processor 580 and the input unit 530 to the memory 520.

The input unit 530 may be configured to receive input digit or character information, and generate a keyboard, mouse, joystick, optical, or track ball signal input related to a user setting and function control. The input unit 530 may include an image input device 531 and another input device 532. The image input device 531 may be a camera, or may be a photoelectric scanning device. In addition to the image input device 531, the input unit 530 may further include the another input device 532. The another input device 532 may include, but not limited to, one or more of a physical keyboard, a functional key (such as a volume control key or a switch key), a track ball, a mouse, and a joystick.

The display unit 540 may be configured to display information input by the user or information provided for the user, and various graphical user interfaces of the electronic device 500. The graphical user interfaces may be formed by a graph, a text, an icon, a video, and any combination thereof. The display unit 540 may include a display panel 541. Optionally, the display panel 541 may be configured by using a liquid crystal display (LCD), an organic light-emitting diode (OLED), or the like.

The electronic device 500 may further include at least one sensor 550, such as an optical sensor, a motion sensor, and other sensors. The optical sensor may include an ambient light sensor and a proximity sensor. The ambient light sensor may adjust luminance of the display panel 541 according to brightness of the ambient light. The proximity sensor may switch off the display panel 541 and/or backlight when the electronic device 500 is moved to the ear. As one type of motion sensor, a gravity acceleration sensor may detect magnitude of accelerations in various directions (generally on three axes), may detect magnitude and a direction of the gravity when static, and may be applied to an application that recognizes the attitude of the mobile phone (for example, switching between landscape orientation and portrait orientation, a related game, and magnetometer attitude calibration), a function related to vibration recognition (such as a pedometer and a knock), and the like. Other sensors such as a gyroscope, a barometer, a hygrometer, a thermometer, and an infrared sensor, which may be configured in the electronic device 500, are not further described herein.

The audio circuit 560, a speaker 561, and a microphone 562 may provide audio interfaces between the user and the electronic device 500. The audio circuit 560 may convert received audio data into an electrical signal and transmit the electrical signal to the speaker 561. The speaker 561 converts the electrical signal into a sound signal and outputs the sound signal. According to another embodiment, the microphone 562 converts a collected sound signal into an electrical signal. After receiving the electrical signal, the audio circuit 560 converts the electrical signal into audio data, and then outputs the audio data. After being processed by the processor 580, the audio data is transmitted through the RF circuit 510 to, for example, another electronic device or the audio data is outputted to the memory 520 for further processing. The audio circuit 560 may further include an earplug jack, so as to provide communication between a peripheral earphone and the electronic device 500.

Wi-Fi belongs to a short distance wireless transmission technology. The device 500 may help, by using the Wi-Fi unit 570, a user to receive and transmit an email, browse a web page, and access streaming media, and so on, which provides wireless broadband Internet access for the user. Although FIG. 14 shows the Wi-Fi module 570, it may be understood that the Wi-Fi module may not be a required component of the electronic device 500, and when required, the Wi-Fi module may be omitted as long as the scope of the essence of the present disclosure is not changed.

The processor 580 is the control center of the electronic device 500, and is connected to various parts of the electronic device by using various interfaces and lines. By running or executing the software program and/or module stored in the memory 520, and invoking data stored in the memory 520, the processor performs various functions and data processing of the electronic device 500, thereby performing overall monitoring on the electronic device. Optionally, the processor 580 may include one or more processing cores. Preferably, the processor 580 may integrate an application processor and a modem processor, where the application processor mainly processes an operating system, a user interface, an application program, and the like, and the modem processor mainly processes wireless communication. It may be understood that the foregoing modem may either not be integrated into the processor 580.

The electronic device 500 further includes a chip 582 including a multiply accumulate module shown in any one of FIG. 4 to FIG. 8. The chip 582 including a multiply accumulate module may implement the control method provided in the foregoing embodiments. FIG. 14 shows a connection manner of the chip 582 including a multiply accumulate module in the electronic device 500, but the connection method of the chip 582 including a multiply accumulate module in the electronic device 500 is not limited to the foregoing method. Alternatively, an adaptive connection may be made according to functions that need to be implemented. For example, when it requires that the chip 582 including a multiply accumulate module needs to complete the processing of an image, the chip including a multiply accumulate module may be directly connected to an image input device 531.

The electronic device 500 further includes the power supply 590 (such as a battery) for supplying power to the components. Preferably, the power supply may logically connect to the processor 580 by using a power supply management system, thereby implementing functions, such as charging, discharging, and power consumption management, by using the power supply management system. The power supply 590 may further include one or more of a direct current or alternating current power supply, a re-charging system, a power failure detection circuit, a power supply converter or inverter, a power supply state indicator, and any other components.

Although not shown in the figure, the electronic device 500 may further include a Bluetooth module and the like, and details were already described herein.

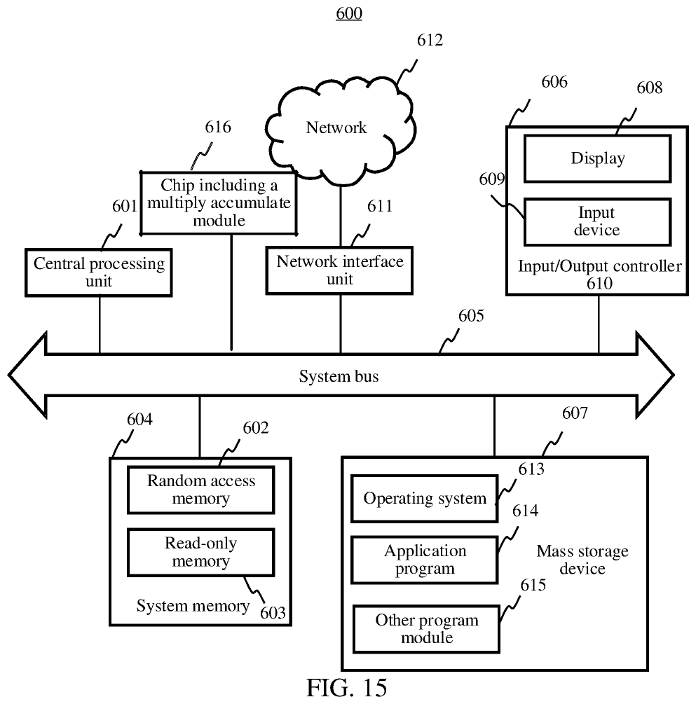

FIG. 15 is a schematic structural diagram of a server provided in an embodiment of this application. The server is configured to implement the control method provided in the foregoing embodiments.

The server 600 includes a central processing unit (CPU) 601, a system memory 604 including a random access memory (RAM) 602 and a read-only memory (ROM) 603, and a system bus 605 connecting the system memory 604 and the CPU 601. The server 600 further includes a basic input/output system (I/O system) 606 for transmitting information between components in a computer, and a mass storage device 607 used for storing an operating system 613, an application program 614, and another program module 615.

The basic I/O system 606 includes a display 608 configured to display information and an input device 609 such as a mouse or a keyboard that is configured to input information by a user. The display 608 and the input device 609 are both connected to the CPU 601 by using an input/output controller 610 connected to the system bus 605. The basic I/O system 606 may further include the input/output controller 610, to receive and process inputs from a plurality of other devices, such as the keyboard, the mouse, or an electronic stylus. Similarly, the input/output controller 610 further provides an output to a display screen, a printer or another type of an output device.

The mass storage device 607 is connected to the CPU 601 by using a mass storage controller (not shown) connected to the system bus 605. The mass storage device 607 and an associated computer-readable medium provide non-volatile storage for the server 600. That is, the mass storage device 607 may include a computer readable medium (not shown), such as a hard disk or a CD-ROM drive.

Without loss of generality, the computer-readable medium may include a computer storage medium and a communication medium. The computer-storage medium includes volatile and non-volatile media, and removable and non-removable media implemented by using any method or technology used for storing information such as computer-readable instructions, data structures, program modules, or other data. The computer-storage medium includes a RAM, a ROM, an erasable programmable ROM (EPROM), an electrically erasable programmable ROM (EEPROM), a flash memory or another solid-state storage technology, a CD-ROM, a DVD or another optical storage, a magnetic cassette, a magnetic tape, or a magnetic disk storage or another magnetic storage device. Certainly, a person skilled in the art may learn that the computer storage medium is not limited to the foregoing several types. The system memory 604 and the mass storage device 607 may be collectively referred to as a memory.

According to the embodiments of this application, the server 600 may further be connected, by using a network such as the Internet, to a remote computer on the network and run. That is, the server 600 may be connected to a network 612 by using a network interface unit 611 connected to the system bus 605, or may be connected to another type of network or a remote computer system (not shown) by using the network interface unit 611.

The server 600 further includes a chip 616 including a multiply accumulate module shown in any one of FIG. 4 to FIG. 8, and a multiply accumulate module 616 and another module in the server 600 are connected through a system bus. The chip 616 including a multiply accumulate module may implement the control method provided in the foregoing embodiments.

The sequence numbers of the foregoing embodiments of this application are merely for description purposes, and are not intended to indicate the preference among the embodiments.

A person of ordinary skill in the art may understand that all or some of the steps of the foregoing embodiments may be implemented by hardware, or may be implemented a program instructing related hardware. The program may be stored in a computer-readable storage medium. The storage medium may be: a ROM, a magnetic disk, or an optical disc.

The foregoing descriptions are merely example embodiments of this application, but are not intended to limit this application. Any modification, equivalent replacement, or improvement and the like made within the spirit and principle of this application fall within the protection scope of this application.

What is claimed is:

1. A chip comprising a multiply accumulate module, the multiply accumulate module comprising:
a first input end and a second input end configured to input multiplication numbers;
an upper-level input end configured to input an addition number;
a mode selection end configured to select a fixed-point arithmetic mode or a floating-point arithmetic mode and a module output end;
a fixed-point general-purpose unit;
a floating-point special-purpose unit; and
an output selection unit;
wherein the fixed-point general-purpose unit is separately connected to the first input end, the second input end, the upper-level input end, and the mode selection end, further wherein a fixed-point output end of the fixed-point general-purpose unit is separately connected to the output selection unit and the floating-point special-purpose unit;
wherein the floating-point special-purpose unit is separately connected to the first input end, the second input end, the upper-level input end, the fixed-point output end, and the mode selection end, further wherein a floating-point output end of the floating-point special-purpose unit is connected to the output selection unit; and
wherein the output selection unit is configured to:
connect the fixed-point output end to the module output end when an arithmetic mode indicated by the mode selection end is the fixed-point arithmetic mode; and
connect the floating-point output end to the module output end when the arithmetic mode is the floating-point arithmetic mode.

2. The chip according to claim 1, wherein when the arithmetic mode is the fixed-point arithmetic mode, the fixed-point general-purpose unit is configured to:
multiply a first operand A inputted by the first input end by a second operand B inputted by the second input end;
add a third operand C inputted by the upper-level input end; and
output a fixed-point operation result from the fixed-point output end.

3. The chip according to claim 1, wherein when the arithmetic mode is the floating-point arithmetic mode, the fixed-point general-purpose unit is configured to:
perform calculation of a multiplication part in a floating-point multiply accumulate operation on a first operand A inputted by the first input end and a second operand B inputted by the second input end; and
output a first intermediate result from the fixed-point output end; and
wherein the floating-point special-purpose unit is configured to:
perform operation of an addition part in the floating-point multiply accumulate operation on the first operand A inputted by the first input end, the second operand B inputted by the second input end, a third operand C inputted by the upper-level input end, and the first intermediate result inputted by the fixed-point output end; and
output a floating-point operation result from the floating-point output end.

4. The chip according to claim 3, wherein the floating-point special-purpose unit comprises:
an adder A;
an adder B;
an adder C;
a shift unit;
a search unit; and
a floating-point operation result output unit;
wherein an output end of the adder A is separately connected to an output end of the fixed-point general-purpose unit and the upper-level input end;
wherein an input end of the adder B is separately connected to the fixed-point output end of the fixed-point general-purpose unit, the upper-level input end, and an output end of the shift unit;
wherein an input end of the adder C is separately connected to the output end of the fixed-point general-purpose unit and an output end of the search unit;
wherein an input end of the shift unit is separately connected to an output end of the adder A and an output end of the adder B;
wherein an input end of the search unit is separately connected to an output end of the adder B and an output end of the adder C; and
wherein the floating-point operation result output unit is separately connected to the output end of the adder B and the output end of the search unit.

5. The chip according to claim 4, wherein the first operand A, the second operand B, and the third operand C are floating-point numbers, the floating-point number comprising an exponent part and a decimal part;
the fixed-point general-purpose unit is configured to:
multiply a decimal part of the first operand A by a decimal part of the second operand B, to obtain the first intermediate result; and
add an exponent part of the first operand A and an exponent part of the second operand B, to obtain a first exponential sum;
the adder A is configured to:
add the first exponential sum and a negative value of an exponent part of the third operand C, to obtain a second exponential sum;
the shift unit is configured to:
obtain a shift object and a shift bit number according to the second exponential sum, the shift object being the first intermediate result or a decimal part of the third operand C; and
shift the first intermediate result according to the shift bit number when the shift object is the first intermediate result, to obtain a shifted first intermediate result; or shift the decimal part of the third operand C according to the shift bit number when the shift object is the decimal part of the third operand C, to obtain a shifted decimal part of the third operand C;
the adder B is configured to:
add the shifted first intermediate result and the decimal part of the third operand C when the shift object is the first intermediate result, to obtain a decimal sum; or
add the first intermediate result and the shifted decimal part of the third operand C when the shift object is the decimal part of the third operand C, to obtain the decimal sum;
the search unit is configured to:
obtain, according to the decimal sum, a decimal result and a relative offset value of an exponent obtained through calculation, and
obtain an exponent result of the floating-point operation result from the adder C;
the adder C is configured to:
add the relative offset value and the first exponential sum, to obtain the exponent result; and
the floating-point operation result output unit is configured to:
determine a sign bit of the floating-point operation result according to a sign bit of the decimal sum; and
splice the sign bit of the floating-point operation result, the decimal result, and the exponent result together, to generate the floating-point operation result.

6. The chip according to claim 5, wherein the multiply accumulate module further comprises:
a data recombiner;
the first input end and the second input end are connected to the fixed-point general-purpose unit by using the data recombiner; and
the data recombiner is configured to:
recombine the first operand A from the first input end and the second operand B from the second input end into m groups of first suboperands A and m groups of second suboperands B respectively when the arithmetic mode is a first fixed-point arithmetic mode, a bit width k of the first/second suboperand=a first bit width 2^{N} of the first/second operand/m; and
split the first operand A and the second operand B into m groups of fourth suboperands D and m groups of fifth suboperands E when the arithmetic mode is a second fixed-point arithmetic mode, a bit width k of the fourth/fifth suboperand=a second bit width 2^{N} of the fourth/fifth operand/m,
the second bit width/the first bit width=2^{M}, m, k, and N being positive integers, and M being any positive integer less than N.

7. The chip according to claim 6, wherein the fixed-point general-purpose unit is further configured to:
when the arithmetic mode is the first fixed-point arithmetic mode, multiply the m groups of first suboperands A by the m groups of second suboperands B;
respectively add m third suboperands C inputted by the upper-level input end; and
output a fixed-point operation result from the fixed-point output end; and
the fixed-point general-purpose unit is further configured to:
when the arithmetic mode is the second fixed-point arithmetic mode, multiply the m groups of fourth suboperands D by the m groups of fifth suboperands E;
respectively add the m third suboperands C inputted by the upper-level input end; and
output a fixed-point operation result from the fixed-point output end.

8. The chip according to claim 6, wherein the data recombiner comprises m groups of recombination output ends, the i^{th} group of recombination output ends in the m groups of recombination output ends comprising a first recombination output end Aᵢ and a second recombination output end Bᵢ;
the fixed-point general-purpose unit comprises
$$X = {( \frac{{2}^{N}}{h} )}^{2}$$
multipliers and
$$X = {( \frac{{2}^{N}}{h} )}^{2}$$
adders, h being a minimum value of the second bit width, and h and X being positive integers; and
a first input end of the j^{th} multiplier in the
$$X = {( \frac{{2}^{N}}{h} )}^{2}$$
multipliers is connected to a first recombination output end A_{f} in the f^{th} group of recombination output ends, and a second input end of the j^{th} multiplier is connected to a second recombination output end Bₜ in the t^{th} group of recombination output ends,
f=j−(t−1)*m, t=ceil(j/m), ceil being rounding up, i and j being positive integers, and i being less than or equal to m.

9. The chip according to claim 8, wherein
the j^{th} multiplier is configured to multiply the f^{th} group of suboperands A_{f}/D_{f} of the first operand A by the t^{th} group of suboperands Bₜ/Eₜ of the second operand B.

10. The chip according to claim 9, wherein the data recombiner comprises two groups of recombination output ends, the two groups of recombination output ends comprising a first recombination output end A₁ and a second recombination output end B₁ in a first group of recombination output ends and a first recombination output end A₂ and a second recombination output end B₂ in a second group of recombination output ends; and the upper-level input end comprises a first input end C₁ and a second input end C₂;
the fixed-point general-purpose unit comprises:
a multiplier 1;
a multiplier 2;
a multiplier 3;
a multiplier 4;
an adder 1;
an adder 2;
an adder 3;
an adder 4; and
a fixed-point operation result selection unit;
wherein an input end of the multiplier 1 is separately connected to the first recombination output end A₁ and the second recombination output end B₁, an input end of the multiplier 2 is separately connected to the first recombination output end A₂ and the second recombination output end B₁, an input end of the multiplier 3 is separately connected to the first recombination output end A₁ and the second recombination output end B₂, and an input end of the multiplier 4 is separately connected to the first recombination output end A₂ and the second recombination output end B₂;
wherein an input end of the adder 1 is separately connected to an output end of the multiplier 1 and an output end of the multiplier 2, an input end of the adder 2 is separately connected to an output end of the multiplier 3 and an output end of the multiplier 4, an input end of the adder 3 is separately connected to an output end of the adder 1, an output end of the adder 4, and the first input end C₁, an input end of the adder 4 is separately connected to the output end of the adder 1, the output end of the adder 2, and the second input end C₂, the first input end A, and the second input end; and
wherein an input end of the fixed-point operation result selection unit is separately connected to the output end of the adder 3 and the output end of the adder 4.

11. The chip according to claim 10, wherein the third operand C comprises two parts, namely, a third suboperand C₁ and a third suboperand C₂;
wherein the multiplier 1 is configured to multiply data outputted by the first recombination output end A₁ by data outputted by the second recombination output end B₁, to obtain a first product;
wherein the multiplier 2 is configured to multiply data outputted by the first recombination output end A₂ by the data outputted by the second recombination output end B₁, to obtain a second product;
wherein the multiplier 3 is configured to multiply the data outputted by the first recombination output end A₁ by data outputted by the second recombination output end B₂, to obtain a third product;
wherein the multiplier 4 is configured to multiply the data outputted by the first recombination output end A₂ by the data outputted by the second recombination output end B₂, to obtain a fourth product;
wherein the adder 1 is configured to add the first product and the second product, to obtain a first addition sum;
wherein the adder 2 is configured to add the third product and the fourth product, to obtain a second addition sum;
wherein the adder 3 is configured to add the first addition sum, the third suboperand C₁, a carry value of the adder 4, to obtain a third addition sum;
wherein the adder 4 is configured to add the first addition sum, the second addition sum, and the third suboperand C₂, to obtain a fourth addition sum; and
wherein the fixed-point operation result selection unit is configured to splice the third addition sum and the fourth addition sum together, to obtain the fixed-point operation result.

12. The chip according to claim 10, wherein the third operand C comprises two parts, a third suboperand C₁ and a third suboperand C₂;
wherein the multiplier 1 is configured to multiply data outputted by the first recombination output end A₁ by data outputted by the second recombination output end B₁, to obtain a first product;
wherein the multiplier 4 is configured to multiply the data outputted by the first recombination output end A₂ by the data outputted by the second recombination output end B₂, to obtain a fourth product;
wherein the adder 3 is configured to add the first product and the third suboperand C₁, to obtain a fifth addition sum;
wherein the adder 4 is configured to add the fourth product and the third suboperand C₂, to obtain a sixth addition sum; and
wherein the fixed-point operation result selection unit is configured to splice the fifth addition sum and the sixth addition sum together, to obtain the fixed-point operation result.

13. The chip according to claim 12, comprising several systolic arrays, each systolic array comprising X*Y multiply accumulate modules; and for the same systolic array, a module output end of a multiply accumulate module in the i^{th} row and the j^{th} column being connected to an upper-level input end of a multiply accumulate module in the (i+1)^{th} row and the j^{th} column, and i, j, X, and Y being positive integers.

14. The chip according to claim 12, comprising several systolic arrays, each systolic array comprising X*Y multiply accumulate modules; and for the same systolic array, a module output end of a multiply accumulate module in the i^{th} row and the j^{th} column being connected to an upper-level input end of a multiply accumulate module in the i^{th} row and the (j+1)^{th} column, and i, j, X, and Y being positive integers.

15. The chip according to claim 14, wherein the chip is any one of a central processing unit (CPU), a field programmable gate array (FPGA), an application-specific integrated circuit (ASIC), a graphics processing unit (GPU), or an artificial intelligence (AI) chip.

16. A method comprising:
receiving a first control signal;
controlling, according to the first control signal, a multiply accumulate module in the chip to be in a corresponding arithmetic mode, the arithmetic mode comprising a fixed-point arithmetic mode and a floating-point arithmetic mode;
multiplying, when the arithmetic mode is the fixed-point arithmetic mode, a first operand A by a second operand B, and then adding a third operand C of a calculation result of an upper-level multiply accumulate module, to obtain and output a fixed-point operation result; and
performing calculation of a multiplication part in a floating-point multiply accumulate operation on the first operand A and the second operand B when the arithmetic mode is the floating-point arithmetic mode, to obtain a first intermediate result, and outputting a floating-point operation result after operation of an addition part in the floating-point multiply accumulate operation is performed on the first operand A, the second operand B, the third operand C, and the first intermediate result.

17. The method according to claim 16, wherein the fixed-point arithmetic mode comprises a first fixed-point arithmetic mode and a second fixed-point arithmetic mode, the method is applicable to the chip according to claim 5, and the third operand C comprises m third suboperands C;
wherein the first operand A and the second operand B are recombined into m groups of first suboperands A and m groups of second suboperands B respectively when the arithmetic mode is the first fixed-point arithmetic mode, a bit width k of the first/second suboperand=a first bit width 2^{N} of the first/second operand/m; and
wherein the first operand A and the second operand B are split into m groups of fourth suboperands D and m groups of fifth suboperands E when the arithmetic mode is the second fixed-point arithmetic mode, a bit width k of the fourth/fifth suboperand=a second bit width 2^{N} of the fourth/fifth operand/m,
wherein the second bit width/the first bit width=2M, m, k, and N being positive integers, and M being any positive integer less than N.

18. The method according to claim 16, wherein the performing and outputting further comprises:
multiplying a decimal part of the first operand A and a decimal part of the second operand B, to obtain a first intermediate result;
adding an exponent part of the first operand A and an exponent part of the second operand B, to obtain a first exponential sum;
adding the first exponential sum and a negative value of an exponent part of the third operand C, to obtain a second exponential sum;
obtaining a shift object and a shift bit number according to the second exponential sum, the shift object being the first intermediate result or a decimal part of the third operand C;
shifting the first intermediate result according to the shift bit number, to obtain a shifted first intermediate result, or shifting the decimal part of the third operand C according to the shift bit number, to obtain a shifted decimal part of the third operand C;
adding the shifted first intermediate result and the decimal part of the third operand C, or adding the first intermediate result and the shifted decimal part of the third operand C, to obtain a decimal sum;
obtaining, according to the decimal sum, a decimal result, a sign bit of the floating-point operation result, and a relative offset value of an exponent obtained through calculation;
adding the relative offset value and the first exponential sum, to obtain an exponent result of the floating-point operation result; and
splicing the sign bit of the floating-point operation result, the decimal result, and the exponent result together, to obtain the floating-point operation result.

19. An electronic device, comprising a chip being configured to perform the operations of the method according to claim 16.

20. A non-volatile computer-readable storage medium, storing computer-readable instructions, the computer-readable instructions, when executed by one or more processors, causing the one or more processors to perform the operations of the method according to claim 16.
